(19) United States
(12) Patent Application Publication
(10) Pub. No.: US 2025/0343008 A1
(43) Pub. Date: Nov. 6, 2025

(54) MULTILAYER CERAMIC CAPACITOR

(71) Applicant: Murata Manufacturing Co., Ltd., Nagaokakyo-shi (JP)

(72) Inventor: Kosuke ONISHI, Nagaokakyo-shi (JP)

(21) Appl. No.: 19/272,117

(22) Filed: Jul. 17, 2025

Related U.S. Application Data
(63) Continuation of application No. PCT/JP2024/001184, filed on Jan. 18, 2024.

(30) Foreign Application Priority Data
Apr. 18, 2023 (JP) 2023-067728

(51) Int. Cl. H01G 4/30; H01G 4/232

(52) U.S. Cl. CPC H01G 4/30; H01G 4/232

(57) ABSTRACT

In a multilayer ceramic capacitor, first and second external electrodes respectively include first main surface electrode portions, second main surface electrode portions, third main surface electrode portions, and fourth main surface electrode portions, on a first main surface. When a length of the first main surface electrode portions, is denoted by length A, a length of the second main surface electrode portions, is denoted by length B, a length of the third main surface electrode portions, is denoted by length C, and a length of the fourth main surface electrode portions is denoted by length D, a relationship of length A>length B>length C>length D is satisfied.

### CROSS REFERENCE TO RELATED APPLICATIONS

This application claims the benefit of priority to Japanese Patent Application No. 2023-067728 filed on Apr. 18, 2023 and is a Continuation application of PCT Application No. PCT/JP2024/001184 filed on Jan. 18, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, as electronic equipment on which multilayer ceramic capacitors are mounted has reduced in size, a reduction in height of each of the multilayer ceramic capacitors has been demanded.

For example, Japanese Unexamined Patent Application, Publication No. 2020-136363 discloses a multilayer ceramic capacitor in which the dimension of each of ceramic layers in the lamination direction is less than 0.3 mm. In the multilayer ceramic capacitor described in Japanese Unexamined Patent Application, Publication No. 2020-136363, the external electrode includes a base film made of a sintered metal film and a plating film provided on the base film.

However, in the multilayer ceramic capacitor described in Japanese Unexamined Patent Application, Publication No. 2020-136363, there are cases where the thickness of the external electrode in the lamination direction of the ceramic layers becomes thick or the end portions of the respective films of the external electrode in the middle of the multilayer body are covered with the respective films, and as a result, there is a risk of cracks extending from the tip of the external electrode to the interior of the multilayer ceramic capacitor.

### SUMMARY OF THE INVENTION

Example embodiments of the present invention provide multilayer ceramic capacitors that are each able to reduce or prevent cracks from extending from a tip of an external electrode to an interior of the multilayer ceramic capacitor.

A multilayer ceramic capacitor according to an example embodiment of the present invention includes a multilayer body including a plurality of ceramic layers that are laminated, a first main surface and a second main surface opposed to each other in a lamination direction of the plurality of ceramic layers, a first lateral surface and a second lateral surface opposed to each other in a width direction orthogonal or substantially orthogonal to the lamination direction, a first end surface and a second end surface opposed to each other in a length direction orthogonal or substantially orthogonal to the lamination direction and the width direction, a plurality of first internal electrode layers each alternately laminated with a corresponding one of the plurality of ceramic layers and each exposed at the first end surface, and a plurality of second internal electrode layers each alternately laminated with a corresponding one of the plurality of ceramic layers and each exposed at the second end surface, a first external electrode covering a portion of the first main surface and at least a portion of the first end surface of the multilayer body, and a second external electrode covering a portion of the first main surface and at least a portion of the second end surface of the multilayer body, in which each of the first external electrode and the second external electrode includes a first main surface electrode portion on the first main surface, a second main surface electrode portion on a portion of the first main surface electrode portion, a third main surface electrode portion on a portion of the second main surface electrode portion, and a fourth main surface electrode portion on a portion of the third main surface electrode portion, and in which, on the first main surface, when a length of the first main surface electrode portion in a direction connecting between a middle of the multilayer body and a surface of the multilayer body where the plurality of first internal electrode layers or the plurality of second internal electrode layers are exposed is defined as length A, a length of the second main surface electrode portion in a same direction as the length A is defined as length B, a length of the third main surface electrode portion in the same direction as the length A is defined as length C, and a length of the fourth main surface electrode portion in the same direction as the length A is defined as length D, a relationship of length A>length B>length C>length D is satisfied.

According to example embodiments of the present invention, it is possible to reduce or prevent cracks from extending from a tip of an external electrode to an interior of the multilayer ceramic capacitor by dispersing the stress generation location.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing a multilayer ceramic capacitor as an example of a multilayer ceramic capacitor according to a first example embodiment of the present invention.

FIG. 2 is a front view showing a multilayer ceramic capacitor as an example of the multilayer ceramic capacitor according to the first example embodiment of the present invention.

FIG. 3 is a plan view showing a multilayer ceramic capacitor as an example of the multilayer ceramic capacitor according to the first example embodiment of the present invention.

FIG. 4 is a schematic cross-sectional view taken along the line IV-IV in FIG. 1.

FIG. 5 is a schematic cross-sectional view taken along the line V-V in FIG. 1.

FIG. 6 is a schematic cross-sectional view taken along the line VI-VI in FIG. 1.

FIG. 7 is a schematic cross-sectional view showing a multilayer ceramic capacitor as an example of a multilayer ceramic capacitor according to a modification of the first example embodiment of the present invention.

FIG. 8 is a schematic cross-sectional view showing a multilayer ceramic capacitor as an example of a multilayer ceramic capacitor according to a modification of the first example embodiment of the present invention.

FIG. 9 is a schematic cross-sectional view showing a multilayer ceramic capacitor as an example of a multilayer ceramic capacitor according to a modification of the first example embodiment of the present invention.

FIG. 10 is a schematic cross-sectional view showing a multilayer ceramic capacitor as an example of a multilayer ceramic capacitor according to a modification of the first example embodiment of the present invention.

FIG. 11 is an external perspective view showing a multilayer ceramic capacitor as an example of a multilayer ceramic capacitor according to a second example embodiment of the present invention.

FIG. 12 is a schematic cross-sectional view taken along the line XII-XII in FIG. 11, and is a schematic cross-sectional view for explaining the configuration of a multilayer ceramic capacitor which is an example of the multilayer ceramic capacitor according to the second example embodiment of the present invention.

FIG. 13 is a schematic cross-sectional view taken along the line XIII-XIII in FIG. 11, and is a schematic cross-sectional view for explaining the configuration of a multilayer ceramic capacitor which is an example of the multilayer ceramic capacitor according to the second example embodiment of the present invention.

FIG. 14 is a schematic cross-sectional view taken along the line XIV-XIV in FIG. 11, and is a schematic cross-sectional view for explaining the configuration of a multilayer ceramic capacitor which is an example of the multilayer ceramic capacitor according to the second example embodiment of the present invention.

FIG. 15 is a schematic cross-sectional view taken along the line XV-XV in FIG. 11, and is a schematic cross-sectional view for explaining the configuration of a multilayer ceramic capacitor which is an example of the multilayer ceramic capacitor according to the second example embodiment of the present invention.

FIG. 16 is a schematic cross-sectional view taken along the line XVI-XVI in FIG. 11, and is a schematic cross-sectional view for explaining the configuration of a multilayer ceramic capacitor which is an example of the multilayer ceramic capacitor according to the second example embodiment of the present invention.

FIG. 17 is an exploded perspective view of a multilayer body shown in FIG. 11.

FIG. 18 is an external perspective view showing a multilayer ceramic capacitor as an example of a multilayer ceramic capacitor according to a third example embodiment of the present invention.

FIG. 19 is a schematic cross-sectional view taken along the line XV-XV in FIG. 11, and is a schematic cross-sectional view for explaining the configuration of a multilayer ceramic capacitor which is an example of the multilayer ceramic capacitor according to the third example embodiment of the present invention.

FIG. 20 is a schematic cross-sectional view taken along the line XX-XX in FIG. 11, and is a schematic cross-sectional view for explaining the configuration of a multilayer ceramic capacitor which is an example of the multilayer ceramic capacitor according to the third example embodiment of the present invention.

### DETAILED DESCRIPTION OF THE EXAMPLE EMBODIMENTS

Example embodiments of the present invention will be described in detail below with reference to the drawings.

Hereinafter, multilayer ceramic capacitors will be described as example embodiments of the present invention.

### A. First Example Embodiment

### 1. Multilayer Ceramic Capacitor

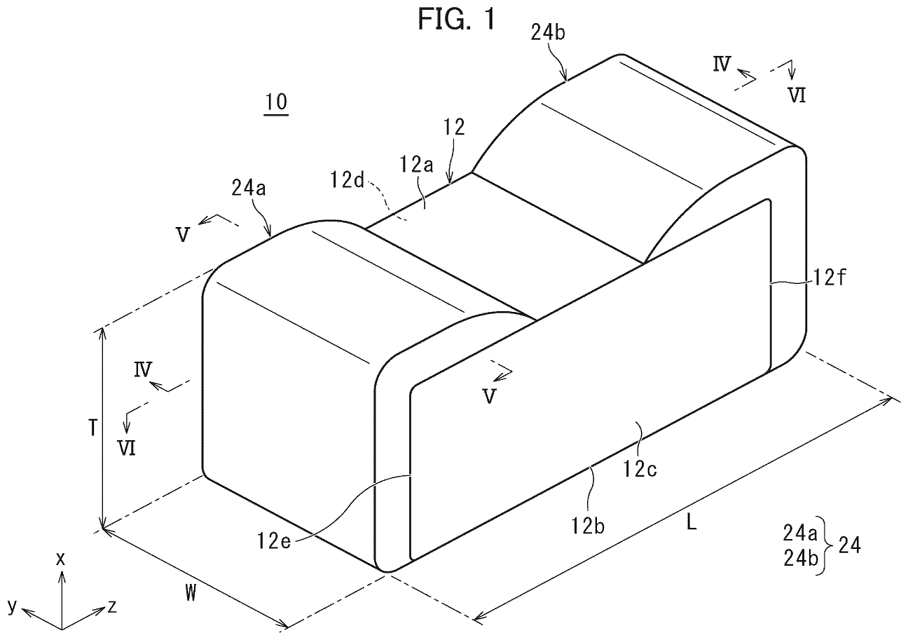

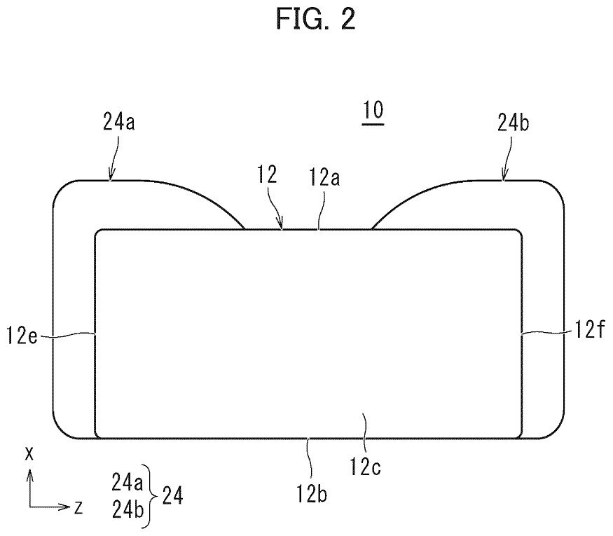

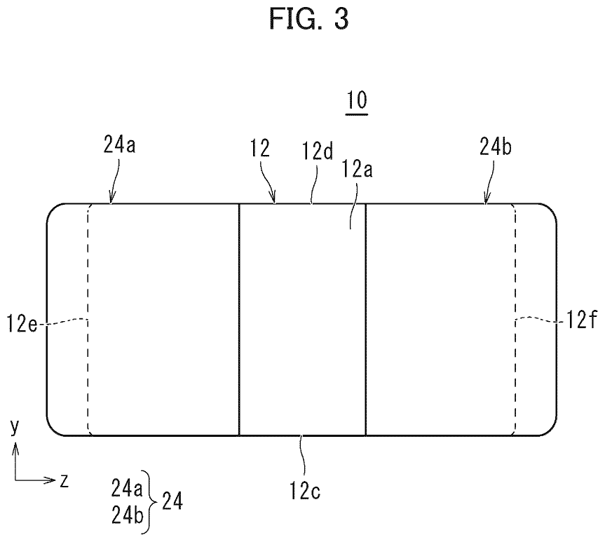

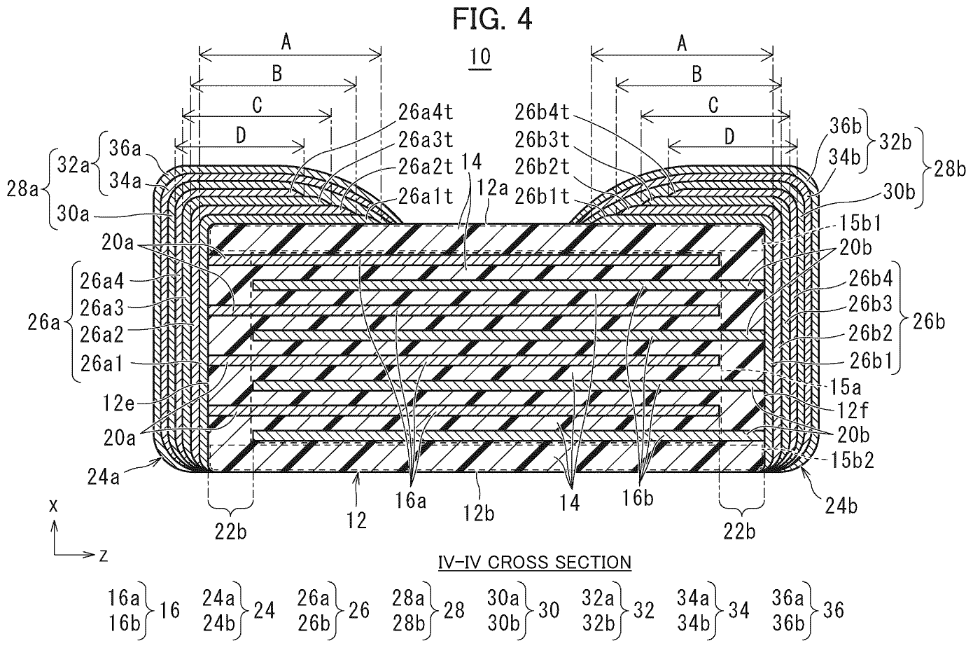

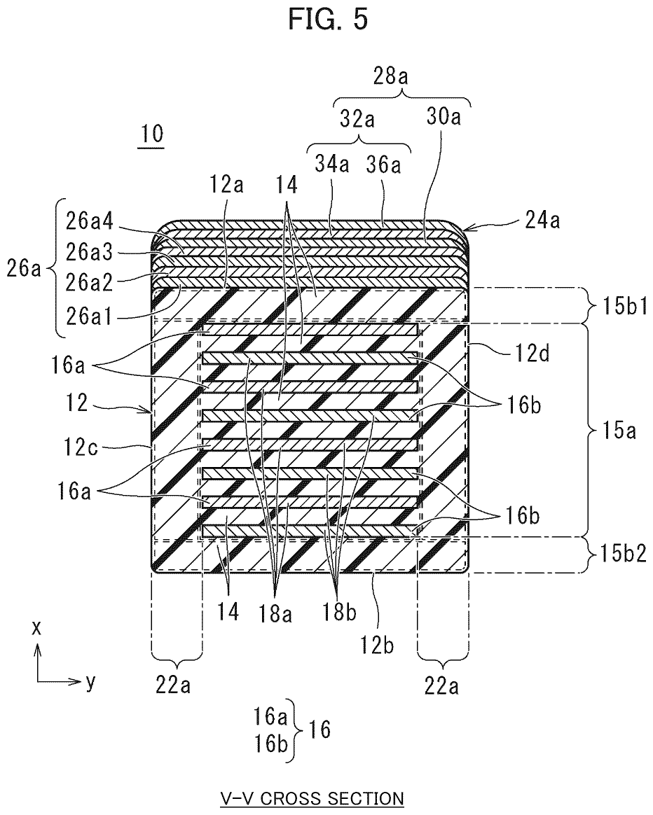

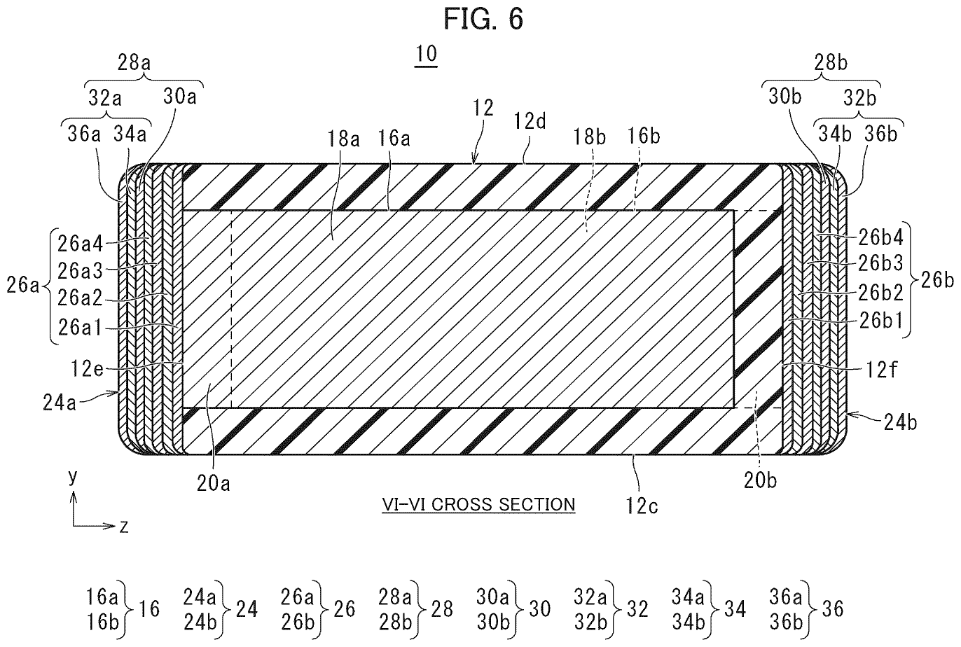

A multilayer ceramic capacitor 10 as an example of a multilayer according to a first example embodiment of the present invention will be described. FIG. 1 is an external perspective view showing a multilayer ceramic capacitor as an example of a multilayer ceramic capacitor according to a first example embodiment of the present invention. FIG. 2 is a front view showing a multilayer ceramic capacitor as an example of the multilayer ceramic capacitor according to the first example embodiment of the present invention. FIG. 3 is a plan view showing a multilayer ceramic capacitor as an example of the multilayer ceramic capacitor according to the first example embodiment of the present invention. FIG. 4 is a schematic cross-sectional view taken along the line IV-IV in FIG. 1. FIG. 5 is a schematic cross-sectional view taken along the line V-V in FIG. 1. FIG. 6 is a schematic cross-sectional view taken along the line VI-VI in FIG. 1.

The multilayer ceramic capacitor 10 includes a multilayer body 12 and external electrodes 24. Hereinafter, each configuration will be described in the order of the multilayer body 12 and the external electrodes 24.

### Multilayer Body

The multilayer body 12 includes a plurality of laminated ceramic layers 14 and a plurality of laminated internal electrode layers 16. Further, the multilayer body 12 includes a first main surface 12a and a second main surface 12b opposed to each other in the height direction x which is the lamination direction of the plurality of ceramic layers 14, a first lateral surface 12c and a second lateral surface 12d opposed to each other in the width direction y orthogonal or substantially orthogonal to the height direction x, and a first end surface 12e and a second end surface 12f opposed to each other in the length direction z orthogonal or substantially orthogonal to the height direction x and the width direction y. The multilayer body 12 includes rounded corner portions and rounded ridge portions. Each of the corner portions refers to a portion where three adjacent surfaces of the multilayer body 12 intersect with one another, and each of the ridge portions refers to a portion where two adjacent surfaces of the multilayer body 12 intersect with each other. The first main surface 12a and the second main surface 12b, the first lateral surface 12c and the second lateral surface 12d, and the first end surface 12e and the second end surface 12f may be partially or entirely uneven.

As shown in FIGS. 4 and 5, the multilayer body 12 includes an effective layer portion 15a in which a plurality of internal electrode layers 16 are opposed to each other in a height direction x connecting the first main surface 12a and the second main surface 12b, a first outer layer portion 15b1 including a plurality of ceramic layers 14 located between the first main surface 12a and the internal electrode layer 16 located closest to the first main surface 12a, and a second outer layer portion 15b2 including a plurality of ceramic layers 14 located between the second main surface 12b and the internal electrode layer 16 located closest to the second main surface 12b.

The first outer layer portion 15b1 is an aggregate of the plurality of ceramic layers 14 located adjacent to the first main surface 12a of the multilayer body 12 and located between the first main surface 12a and the internal electrode layer 16 closest to the first main surface 12a.

The second outer layer portion 15b2 is an aggregate of the plurality of ceramic layers 14 located adjacent to the second main surface 12b of the multilayer body 12 and located between the second main surface 12b and the internal electrode layer 16 closest to the second main surface 12b.

The effective layer portion 15a is a region sandwiched between the first outer layer portion 15b1 and the second outer layer portion 15b2.

The multilayer body 12 includes lateral portions 22a (W gap) of the multilayer body 12 located between the effective layer portion 15a and the first lateral surface 12c and between the effective layer portion 15a and the second lateral surface 12d. Further, the multilayer body 12 includes end portions 22b (L gap) of the multilayer body 12 located between the effective layer portion 15a and the first end surface 12e and between the effective layer portion 15a and the second end surface 12f, and including extension electrode portions of either one of the first internal electrode layers 16a or the second internal electrode layers 16b described later.

The number of ceramic layers 14 to be laminated is not particularly limited, but is, for example, preferably 3 or more and 1000 or less including the first outer layer portion 15b1 and the second outer layer portion 15b2. The thickness of each of the ceramic layers 14 is, for example, preferably about 2.0 μm or more and about 80 μm or less.

The ceramic layers 14 can be made of, for example, a dielectric material. As the dielectric material, for example, a dielectric ceramic including a main component such as BaTiO₃, CaTiO₃, SrTiO₃, or CaZrO₃ can be used. In addition, in accordance with the desired characteristics of the multilayer body, for example, a subcomponent having a smaller content than the main component such as a Mn compound, a Fe compound, a Cr compound, a Co compound, or a Ni compound may be added.

The ceramic layer 14 may include a plurality of crystal grains including, for example, a perovskite compound having BaTiO₃ as a basic structure.

As the thickness of the ceramic layer 14 is smaller, the capacitance of a capacitor becomes larger, Therefore, the crystal grain size is, for example, preferably about 1 μm or less.

Here, each of the plurality of ceramic layers 14 for the inner layer defining the effective layer portion 15a is sandwiched between a first internal electrode layer 16a and a second internal electrode layer 16b of the plurality of internal electrode layers 16. Each of the ceramic layers 14 for the inner layer is made of, for example, dielectric ceramic particles including a perovskite structure and mainly including a perovskite compound including Ba and Ti. In addition, at least one of Si, Mg, Ba, and Mn may be added as an additive to these main components. The additive is present between the ceramic particles.

The ceramic layers 14 for the outer layer defining the first outer layer portion 15b1 and the second outer layer portion 15b2 is made of the same dielectric ceramic material as the ceramic layers 14 for the inner layer. The ceramic layers 14 for the outer layer may be made of a material different from that of the ceramic layers 14 for the inner layer. In addition, in a case where the ceramic layers 14 for the first outer layer portion 15b1 and the second outer layer portion 15b2 each include a plurality of layers, it is preferable that segregation portions of Si in the ceramic layers 14 located closest to the first internal electrode layers 16a and the second internal electrode layers 16b are fewer than segregation portions in the other ceramic layers 14 for the outer layers. This makes it possible to improve the bending strength of the multilayer ceramic capacitor from the height direction x. Each of the ceramic layers 14 for the first outer layer portion 15b1 and the second outer layer portion 15b2 may include a plurality of laminated layers or a single-layer configuration.

### Internal Electrode Layers

As shown in FIGS. 4 and 5, the internal electrode layers 16 include the first internal electrode layers 16a and the second internal electrode layers 16b. The first internal electrode layers 16a and the second internal electrode layers 16b are alternately laminated with a corresponding one of the ceramic layers 14 interposed therebetween.

Each of the first internal electrode layers 16a is provided on the surface of a corresponding one of the ceramic layers 14. Each of the first internal electrode layers 16a includes a first counter electrode portion 18a opposed to a corresponding one of the second internal electrode layers 16b, and a first extension electrode portion 20a located at one end of the first internal electrode layer 16a and extending from the first counter electrode portion 18a to the first end surface 12e of the multilayer body 12. The first extension electrode portion 20a includes an end portion which extends toward and is exposed at the first end surface 12e.

The shape of the first counter electrode portion 18a of each of the first internal electrode layers 16a is not particularly limited, but is, for example, preferably rectangular or substantially rectangular in a plan view. However, the corner portion in a plan view may be rounded, or the corner portion may be oblique in a plan view (tapered shape). Alternatively, the corner portion may have a tapered shape in a plan view which is sloped toward either side.

The shape of the first extension electrode portion 20a of each of the first internal electrode layers 16a is not particularly limited, but is, for example, preferably rectangular or substantially rectangular in a plan view. However, the corner portion in a plan view may be rounded, or the corner portion may be oblique in a plan view (tapered shape). Alternatively, the corner portion may have a tapered shape in a plan view which is sloped toward either side.

The width of the first counter electrode portion 18a of each of the first internal electrode layers 16a and the width of the first extension electrode portion 20a of each of the first internal electrode layers 16a may be the same or substantially the same, or either one may be narrower than the other.

Each of the second internal electrode layers 16b is provided on a surface of the ceramic layer 14 different from that of the ceramic layer 14 on which the first internal electrode layer 16a is provided. Each of the second internal electrode layers 16b includes a second counter electrode portion 18b opposed to a corresponding one of the first internal electrode layers 16a and a second extension electrode portion 20b located at one end of the second internal electrode layer 16b and extending from the second counter electrode portion 18b to the second end surface 12f of the multilayer body 12. The second extension electrode portion 20b includes an end portion which extends toward and is exposed at the second end surface 12f.

The shape of the second counter electrode portion 18b of each of the second internal electrode layers 16b is not particularly limited, but is, for example, preferably rectangular or substantially rectangular in a plan view. However, the corner portion in a plan view may be rounded, or the corner portion may be oblique in a plan view (tapered shape). Alternatively, the corner portion may have a tapered shape in a plan view which is sloped toward either side.

The shape of the second extension electrode portion 20b of each of the second internal electrode layer 16b is not particularly limited, but is, for example, preferably rectangular or substantially rectangular in a plan view. However, the corner portion in a plan view may be rounded, or the corner portion may be oblique in a plan view (tapered shape). Alternatively, the corner portion may have a tapered shape in a plan view which is sloped toward either side.

The width of the second counter electrode portion 18b of each of the second internal electrode layers 16b and the width of the second extension electrode portion 20b of each of the second internal electrode layers 16b may be the same or substantially the same, or either one may be narrower than the other.

The first internal electrode layer 16a and the second internal electrode layer 16b can be made of, for example, a metal such as Ni, Cu, Ag, Pd, or Au, or an appropriate electrically conductive material such as an alloy including at least one of these metals such as an Ag—Pd alloy, but are not limited thereto. In the present example embodiment, the first counter electrode portion 18a of each of the first internal electrode layers 16a and the second counter electrode portion 18b of each of the second internal electrode layers 16b are opposed to each other with a corresponding one of the ceramic layers 14 interposed therebetween, such that capacitance is generated and the characteristics of the capacitor are developed.

### External Electrode

As shown in FIGS. 1 to 6, external electrodes 24 are respectively provided on the first end surface 12e and the second end surface 12f of the multilayer body 12.

Each of the external electrodes 24 includes a base electrode layer 26 and a plated layer 28 that covers the base electrode layer 26.

The external electrode 24 includes a first external electrode 24a and a second external electrode 24b.

The first external electrode 24a is provided on the first end surface 12e and a portion of the first main surface 12a of the multilayer body 12. In this case, the first external electrode 24a is electrically connected to the first extension electrode portion 20a of each of the first internal electrode layers 16a. The first external electrode 24a may slightly further extend to a portion of the first lateral surface 12c and a portion of the second lateral surface 12d.

The second external electrode 24b is provided on the second end surface 12f and a portion of the first main surface 12a of the multilayer body 12. In this case, the second external electrode 24b is electrically connected to the second extension electrode portions 20b of each of the second internal electrode layers 16b. The second external electrode 24b may slightly further extend to a portion of the first lateral surface 12c and a portion of the second lateral surface 12d.

The thicknesses of the first external electrode 24a and the second external electrode 24b are preferably, for example, about 0.5 μm or more and about 12 μm or less.

### Base Electrode Layer

The base electrode layer 26 includes a first base electrode layer 26a and a second base electrode layer 26b.

The first base electrode layer 26a covers a portion of the first main surface 12a adjacent to the first end surface 12e of the multilayer body 12 and the first end surface 12e of the multilayer body 12.

The second base electrode layer 26b covers a portion of the first main surface 12a adjacent to the second end surface 12f of the multilayer body 12 and the second end surface 12f of the multilayer body 12.

Each of the first base electrode layer 26a and the second base electrode layer 26b includes a first main surface electrode portion, a second main surface electrode portion, a third main surface electrode portion, and a fourth main surface electrode portion. Specifically, the first base electrode layer 26a has a configuration in which a first main surface electrode portion 26al, a second main surface electrode portion 26a2, a third main surface electrode portion 26a3, and a fourth main surface electrode portion 26a4 are laminated. The second base electrode layer 26b has a configuration in which a first main surface electrode portion 26b1, a second main surface electrode portion 26b2, a third main surface electrode portion 26b3, and a fourth main surface electrode portion 26b4 are laminated.

### Main Surface Electrode Portion

As shown in FIG. 4, the first main surface electrode portion 26a1 is provided on the surface of the multilayer body 12, the second main surface electrode portion 26a2 is provided on the surface of the first main surface electrode portion 26al, the third main surface electrode portion 26a3 is provided on the surface of the second main surface electrode portion 26a2, and the fourth main surface electrode portion 26a4 is provided on the surface of the third main surface electrode portion 26a3.

Here, on the first main surface 12a, a direction is defined which connects between the end portion of the first main surface electrode portion of the first base electrode layer adjacent to the middle of the multilayer body and the surface of the multilayer body where the first internal electrode layers are exposed. More specifically, a direction (hereinafter, referred to as a first reference direction) is defined which connects a first end portion 26a1t of the first main surface electrode portion 26a1 of the first base electrode layer 26a adjacent to the middle of the multilayer body 12 and the first end surface 12e of the multilayer body 12 where each of the first extension electrode portions 20a of the first internal electrode layers 16a are exposed. When the length of the first main surface electrode portion 26a1 in the first reference direction is defined as length A, the length of the second main surface electrode portion 26a2 in the same direction as the length A is defined as length B, the length of the third main surface electrode portion 26a3 in the same direction as the length A is defined as length C, and the length of the fourth main surface electrode portion 26a4 in the same direction as the length A is defined as length D, the relationship of length A>length B>length C>length D is satisfied.

With such a configuration, on the first main surface 12a, since the first main surface electrode portion 26al, the second main surface electrode portion 26a2, the third main surface electrode portion 26a3, and the fourth main surface electrode portion 26a4 of the first base electrode layer 26a are not aligned with one another at the first end portion 26a1t, the second end portion 26a2t, the third end portion 26a3t, and the fourth end portion 26a4t adjacent to the middle of the multilayer body 12, it is possible to disperse the stress, generated at the time of solder shrinkage, of the external electrode 24 to the middle of the multilayer body 12.

Further, on the first main surface 12a, a direction is defined which connects between the end portion of the first main surface electrode portion of the second base electrode layer adjacent to the middle of the multilayer body and the surface of the multilayer body where the second internal electrode layers are exposed. More specifically, a direction (hereinafter, referred to as a second reference direction) is defined which connects the first end portion 26b1t of the first main surface electrode portion 26b1 of the second base electrode layer 26b adjacent to the middle of the multilayer body and the second end surface 12f of the multilayer body 12 where the second extension electrode portions 20b of the second internal electrode layers 16b are exposed. When the length of the first main surface electrode portion 26b1 in the second reference direction is defined as length A, the length of the second main surface electrode portion 26b2 in the same direction as the length A is defined as length B, the length of the third main surface electrode portion 26b3 in the same direction as the length A is defined as length C, and the length of the fourth main surface electrode portion 26b4 in the same direction as the length A is defined as length D, the relationship of length A>length B>length C>length D is satisfied.

With such a configuration, on the first main surface 12a, since the first main surface electrode portion 26b1, the second main surface electrode portion 26b2, the third main surface electrode portion 26b3, and the fourth main surface electrode portion 26b4 of the second base electrode layer 26b are not aligned with one another at the first end portion 26b1t, the second end portion 26b2t, the third end portion 26b3t, and the fourth end portion 26b4t adjacent to the middle of the multilayer body 12, it is possible to disperse the stress, generated at the time of solder shrinkage, of the external electrode 24 to the middle of the multilayer body 12.

As shown in FIG. 4, it is preferable that, in the first reference direction, the first end portion 26a1t of the first main surface electrode portion 26a1 is not covered by the second main surface electrode portion 26a2, the second end portion 26a2t of the second main surface electrode portion 26a2 is not covered by the third main surface electrode portion 26a3, and the third end portion 26a3t of the third main surface electrode portion 26a3 is not covered by the fourth main surface electrode portion 26a4.

With such a configuration, since the stress applied to each of the first end portion 26a1t to the fourth end portion 26a4t of the first main surface electrode portion 26a1 to the fourth main surface electrode portion 26a4 can be concentrated on the outer side of the multilayer body 12 (adjacent to the first end surface 12e) with respect to these end portions, it is possible to disperse the stress, such that the mechanical strength is improved.

Similarly, it is preferable that, in the second reference direction, the first end portion 26b1t of the first main surface electrode portion 26b1 is not covered by the second main surface electrode portion 26b2, the second end portion 26b2t of the second main surface electrode portion 26b2 is not covered by the third main surface electrode portion 26b3, and the third end portion 26b3t of the third main surface electrode portion 26b3 is not covered by the fourth main surface electrode portion 26b4.

With such a configuration, since the stress applied to the first end portion 26b1t to the fourth end portion 26b4t of the first main surface electrode portion 26b1 to the fourth main surface electrode portion 26b4 can be concentrated on the outer side of the multilayer body 12 (adjacent to the second end surface 12f) with respect to these end portions, it is possible to disperse the stress, such that the mechanical strength is improved.

Next, each of the first to fourth main surface electrode portions of the base electrode layer 26 can be formed by, for example, a thin film forming method such as a sputtering method or a vapor deposition method, or by screen printing.

### Case of Thin Film Formation Method

When each of the first to fourth main surface electrode portions is formed by a thin film forming method, the electrode portions may be made of a metal such as, for example, Cu, Cr, Au, Pt, Ag, Sn, Ti, or Ni.

Each of the first to fourth main surface electrode portions can be configured in consideration of each function. For example, the first main surface electrode portions 26a1 and 26b1 may be made of NiCr or the like in consideration of adhesion to ceramics.

At this time, the thickness of each of the first to fourth main surface electrode portions in the direction connecting the first main surface 12a and the second main surface 12b of the multilayer body 12 is, for example, about 10 μm or less. Therefore, the dimension of the multilayer ceramic capacitor 10 in the lamination direction can be sufficiently reduced, such that it is possible to reduce the height.

Each of the first to fourth main surface electrode portions may be provided on at least one of the first main surface 12a or the second main surface 12b of the multilayer body 12. That is, in a case where each of the first to fourth main surface electrode portions is provided only on the first main surface 12a, it is preferable that the amount of a direct plated layer further extending to the first main surface 12a is larger than the amount of a direct plated layer further extending to the second main surface 12b, even when the direct plated layer described later is not provided on the second main surface 12b or is provided on the second main surface 12b.

The change in thickness of each of the first to fourth main surface electrode portions by the sputtering method is provided by changing a sputtering distance. For example, the thickness can be increased by reducing the injection distance to the portion where the main surface electrode portion is to be provided.

### Screen Printing

When the first to fourth main surface electrode portions are formed by screen printing, the ceramic component and the metal are included.

The metal includes at least one of Cu, Ni, Ag, Pd, an Ag—Pd alloy, or Au, for example.

Further, each of the first main surface electrode portions 26a1 and 26b1 may include the same main component as the ceramic layer 14. For example, when the ceramic layer 14 is made of BaTiO₃, each of the first main surface electrode portions 26a1 and 26b1 preferably includes at least a portion of BaTiO₃. With such a configuration, it is possible to improve the adhesiveness between the multilayer body 12 and each of the first main surface electrode portions 26a1 and 26b1.

In addition, in a case where each of the first main surface electrode portions 26a1 and 26b1 includes the same main component as that of the ceramic layers 14, it is possible to further improve the degree of adhesion by simultaneously firing the multilayer body 12 and each of the first main surface electrode portions 26a1 and 26b1. At this time, as the metal component, for example, Ni, Cu, or the like is preferable, but can be appropriately changed depending on the metal component of the internal electrode layers 16.

The thickness of the portion of each of the first to fourth main surface electrode portions provided on the first main surface 12a is, for example, preferably about 0.5 μm or more and about 3.0 μm or less.

### Plated Layer

The plated layer 28 includes a first plated layer 28a and a second plated layer 28b.

The first plated layer 28a covers the first main surface electrode portion 26a1 to the fourth main surface electrode portion 26a4 as the first base electrode layers 26a.

The second plated layer 28b covers the first main surface electrode portion 26b1 to the fourth main surface electrode portion 26b4 as the second base electrode layers 26b.

The plated layer 28 includes a plurality of layers. That is, the plated layer 28 includes a lower plated layer 30 and an upper plated layer 32. The lower plated layer 30 includes a first lower plated layer 30a included in the first plated layer 28a and a second lower plated layer 30b included in the second plated layer 28b. The upper plated layer 32 includes a first upper plated layer 32a included in the first plated layer 28a and a second upper plated layer 32b included in the second plated layer 28b.

The first lower plated layer 30a of the lower plated layer 30 covers the fourth main surface electrode portion 26a4 of the first base electrode layer 26a.

The second lower plated layer 30b of the lower plated layer 30 covers the fourth main surface electrode portion 26b4 of the second base electrode layer 26b.

The lower plated layer 30 preferably includes, for example, at least one metal of Cu, Ni, Sn, Pb, Au, Ag, Pd, Bi, or Zn, or an alloy including the metal. In particular, in the present example embodiment, the lower plated layer 30 is, for example, preferably a Cu plated layer.

The upper plated layer 32 may include a plurality of layers. In the present example embodiment, for example, the upper plated layer 32 includes a two-layer configuration of an intermediate plated layer 34, which is a Ni plated layer, and an upper plated layer 36, which is a Sn plated layer.

In the upper plated layer 32, the first intermediate plated layer 34a covers the first lower plated layer 30a, and the first upper plated layer 36a covers the first intermediate plated layer 34a. Further, the second intermediate plated layer 34b covers the second lower plated layer 30b, and the second upper plated layer 36b covers the second intermediate plated layer 34b.

The intermediate plated layer 34 as the Ni plated layer can prevent the lower plated layer 30 from being eroded by solder when the multilayer ceramic capacitor 10 is mounted. In addition, the upper plated layer 36 as the Sn plated layer can improve the wettability of solder when the multilayer ceramic capacitor 10 is mounted, which facilitates the mounting. In a case where the plated layer 28 includes a three-layer configuration, in addition to the above configuration, for example, it is preferable that a Sn plated layer, a Ni plated layer, and a Sn plated layer are laminated in this order.

The metal ratio per unit volume of the plated layer 28 is, for example, preferably about 99% by volume or more.

The thickness of the plated layer 28 per one plated layer is, for example, preferably about 0.5 μm or more and about 6.0 μm or less.

The dimension in the length direction z of the multilayer ceramic capacitor 10 including the multilayer body 12, the first external electrode 24a, and the second external electrode 24b is defined as L, the dimension in the height direction x of the multilayer ceramic capacitor 10 including the multilayer body 12, the first external electrode 24a, and the second external electrode 24b is defined as T, and the dimension in the width direction y of the multilayer ceramic capacitor 10 including the multilayer body 12, the first external electrode 24a, and the second external electrode 24b is defined as W.

The dimensions of the multilayer ceramic capacitor 10 are, for example, preferably such that the L dimension in the length direction z is about 0.2 mm or more and about 3.2 mm or less, the T dimension in the height direction x is about 0.04 mm or more and about 2.5 mm or less, and the W dimension in the width direction y is about 0.1 mm or more and about 2.5 mm or less.

In the multilayer ceramic capacitor 10 shown in FIG. 1, the first base electrode layer 26a includes a laminate of the first main surface electrode portion 26al, the second main surface electrode portion 26a2, the third main surface electrode portion 26a3, and the fourth main surface electrode portion 26a4, and the second base electrode layer 26b includes a laminate of the first main surface electrode portion 26b1, the second main surface electrode portion 26b2, the third main surface electrode portion 26b3, and the fourth main surface electrode portion 26b4.

On the first main surface 12a, in a direction connecting between the end portion of the first main surface electrode portion of the first base electrode layer adjacent to the middle of the multilayer body and the surface of the multilayer body 12 on which the first internal electrode layers are exposed, more specifically, in the first reference direction connecting between the first end portion 26a1t of the first main surface electrode portion 26a1 of the first base electrode layer 26a adjacent to the middle of the multilayer body 12 and the first end surface 12e of the multilayer body 12 on which the first extension electrode portions 20a of the first internal electrode layers 16a are exposed, when the length of the first main surface electrode portion 26a1 is defined as length A, the length of the second main surface electrode portion 26a2 in the same direction as the length A is defined as a length B, the length of the third main surface electrode portion 26a3 in the same direction as the length A is defined as a length C, and the length of the fourth main surface electrode portion 26a4 in the same direction as the length A is defined as a length D, the relationship of A>length B>length C>length D is satisfied.

On the first main surface 12a, in a direction connecting between the end portion of the first main surface electrode portion of the second base electrode layer adjacent to the middle of the multilayer body and the surface of the multilayer body 12 where the second internal electrode layers are exposed, more specifically, in the second reference direction connecting between the first end portion 26b1t of the first main surface electrode portion 26b1 of the second base electrode layer 26b adjacent to the middle of the multilayer body 12 and the second end surface 12f of the multilayer body 12 where the second extension electrode portions 20b of the second internal electrode layers 16b are exposed, when the length of the first main surface electrode portion 26b1 is defined as length A, when the length of the second main surface electrode portion 26b2 in the same direction as the length A is defined as a length B, the length of the third main surface electrode portion 26b3 in the same direction as the length A is defined as a length C, and the length of the fourth main surface electrode portion 26b4 in the same direction as the length A is defined as a length D, the relationship of length A>length B>length C>length D is satisfied.

With such a configuration, the first main surface electrode portion 26a1 to the fourth main surface electrode portion 26a4 of the first base electrode layer 26a are not aligned with one another at the first end portion 26a1t, the second end portion 26a2t, the third end portion 26a3t, and the fourth end portion 26a4t adjacent to the middle of the multilayer body 12, and the first main surface electrode portion 26b1 to the fourth main surface electrode portion 26b4 of the second base electrode layer 26b are not aligned with one another at the first end portion 26b1t, the second end portion 26b2t, the third end portion 26b3t, and the fourth end portion 26b4t adjacent to the middle of the multilayer body 12. Therefore, it is possible to disperse the stress, generated at the time of solder shrinkage, of the external electrode 24 to the middle of the multilayer body 12.

In addition, the advantageous effects of the present invention are more remarkably provided when the T dimension of the multilayer ceramic capacitor 10 is, for example, about 150 μm or less. Further, when the T dimension is, for example, about 50 μm or less, the multilayer ceramic capacitor 10 has a reduced thickness, and reliability in mechanical strength becomes more necessary, such that the advantageous effects of the present invention are more remarkably provided.

Further, in the multilayer ceramic capacitor 10 shown in FIG. 1, each of the first main surface electrode portion 26a1 to the fourth main surface electrode portion 26a4 of the first base electrode layer 26a and the first main surface electrode portion 26b1 to the fourth main surface electrode portion 26b4 of the second base electrode layer 26b further extend respectively to the first end surface 12e and the second end surface 12f, which are surfaces orthogonal to the first main surface 12a.

With such a configuration, the portions (ridge portions or joints) where the first main surface 12a and each of the first end surface 12e and the second end surface 12f intersect are continuously provided while being covered with each of the first base electrode layer 26a and the second base electrode layer 26b, such that the moisture resistance is improved.

At this time, it is preferable to form the first main surface electrode portion 26a1 to the fourth main surface electrode portion 26a4 and the first main surface electrode portion 26b1 to the fourth main surface electrode portion 26b4 of each of the external electrodes 24 by a sputtering method, for example. Thus, since the first external electrode 24a and the second external electrode 24b, which are the external electrodes 24 having a thickness of, for example, about 10 μm or less, can be formed on each of the first end surface 12e and the second end surface 12f orthogonal to the first main surface 12a, it is possible to reduce the dimensions in the length direction z and the width direction y of the multilayer ceramic capacitor 10.

The length A, the length B, the length C, and the length D of each of the first main surface electrode portion 26a1 to the fourth main surface electrode portion 26a4 of the first base electrode layer 26a and the first main surface electrode portion 26b1 to the fourth main surface electrode portion 26b4 of the second base electrode layer 26b can be measured by the following example of a measurement method.

For example, in the width direction y connecting between the first lateral surface 12c and the second lateral surface 12d of the multilayer body 12, cross section polishing is performed up to about one half of the W dimension in the width direction y. The polished cross section is observed with VHX. When the first extension electrode portions 20a of the first internal electrode layers 16a or the second extension electrode portions 20b of the second internal electrode layers 16b are not present in the cross section, for example, further polishing is performed to about one fourth of the W dimension in the width direction y, such that it is possible to observe the main surface electrode portion directly on the first extension electrode portions 20a of the first internal electrode layers 16a or the second extension electrode portions 20b of the second internal electrode layers 16b.

At this time, in a case where the first main surface electrode portion 26a1 to the fourth main surface electrode portion 26a4 and the first main surface electrode portion 26b1 to the fourth main surface electrode portion 26b4 of the second base electrode layer 26b are formed by, for example, a sputtering method or the like, a method of observing differences in components of the respective main surface electrode portions by WDX, EDX using TEM, or the like can also be used. For example, when the thickness of each layer of the main surface electrode portion is about 1 μm, the composition of each layer can be confirmed by exposing a cross section (about ¼ LT cross section) of the middle portion of the external electrode 24 and performing composition analysis by WDX. When the thickness of each layer of the main surface electrode portion is, for example, about 1 μm or less, the detailed structure can be confirmed by EDX using TEM.

When TEM is used, for example, the field of view is about 1 μm and the magnification is about 20 k times.

When the ridge portions of the multilayer body 12 are rounded, each of the length A, the length B, the length C, and the length D is defined by a linear distance between a perpendicular or substantially perpendicular line drawn from an exposed portion of the extension electrode portion closest to the first main surface 12a among the first extension electrode portions 20a of the first internal electrode layers 16a or the second extension electrode portions 20b of the second internal electrode layers 16b toward the mounting surface of the multilayer ceramic capacitor 10 or the first main surface 12a, and any desired end portion among the first end portion 26a1t to the fourth end portion 26a4t and the first end portion 26b1t to the fourth end portion 26b4t of the first main surface electrode portion 26a1 to the fourth main surface electrode portion 26a4 and the first main surface electrode portion 26b1 to the fourth main surface electrode portion 26b4 of the second base electrode layer 26b.

### (1) First Modification

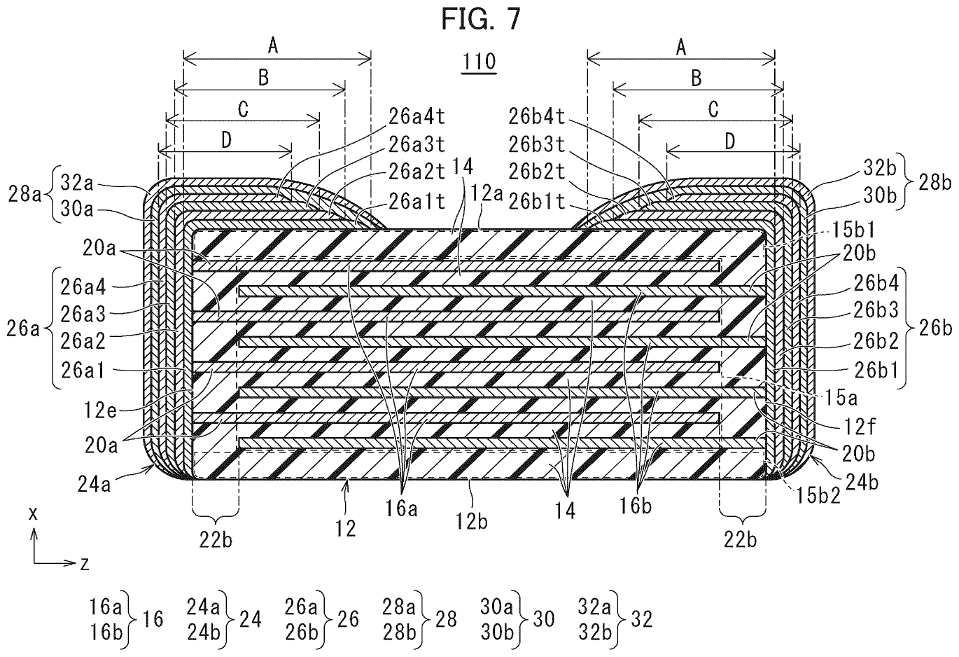

Next, a multilayer ceramic capacitor 110 which is a multilayer ceramic capacitor according to a first modification of the first example embodiment of the present invention will be described. FIG. 7 is a schematic cross-sectional view showing a multilayer ceramic capacitor as an example of a multilayer ceramic capacitor according to a first modification of the first example embodiment of the present invention. The same or corresponding components as those in FIGS. 1 to 6 are denoted by the same reference numerals, and detailed descriptions thereof will be omitted.

In the multilayer ceramic capacitor 110 according to the first modification, as shown in FIG. 7, the plated layer 28 of the external electrode 24 includes two plated layers including a lower plated layer 30 and an upper plated layer 32, and the upper plated layer 32 includes a single layer.

As in the first example embodiment, the lower plated layer 30 preferably includes, for example, at least one metal of Cu, Ni, Sn, Pb, Au, Ag, Pd, Bi, or Zn, or an alloy including the metal.

The upper plated layer 32 is, for example, preferably a Sn plated layer. With such a configuration, it is possible to improve the solder wettability at the time of mounting the multilayer ceramic capacitor 10, which facilitates the mounting.

According to the multilayer ceramic capacitor 110 according to the first modification shown in FIG. 7, it is possible to obtain the same or substantially the same advantageous effects as those of the multilayer ceramic capacitor 10 of FIG. 1.

### (2) Second Modification

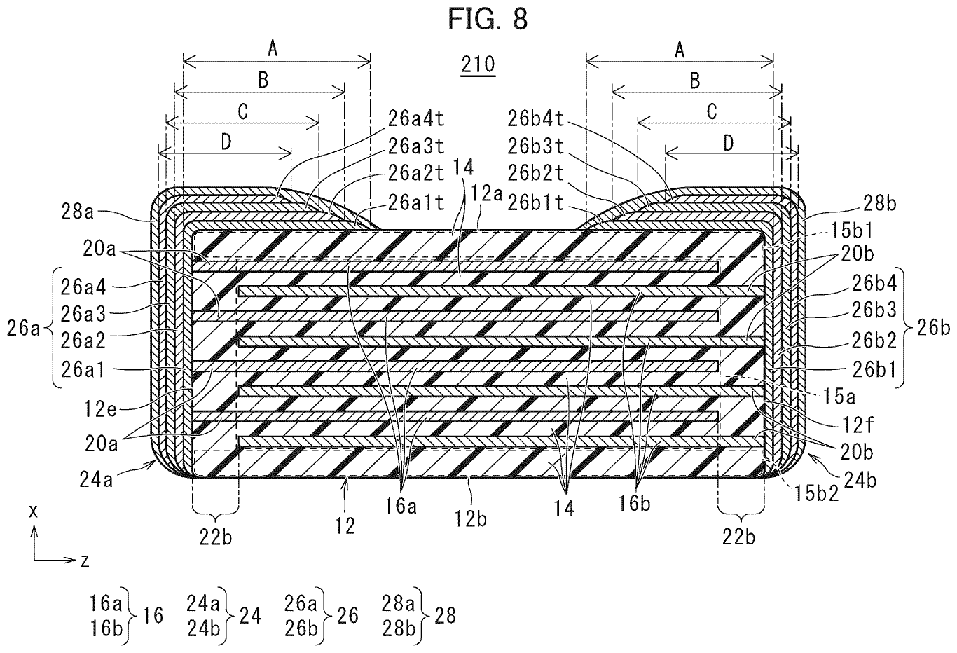

Next, a multilayer ceramic capacitor 210, which is a multilayer ceramic capacitor according to a second modification of the first example embodiment of the present invention, will be described. FIG. 8 is a schematic cross-sectional view showing a multilayer ceramic capacitor as an example of a multilayer ceramic capacitor according to a second modification of the first example embodiment of the present invention. The same components as those in FIGS. 1 to 6 are denoted by the same reference numerals, and detailed descriptions thereof will be omitted.

In the multilayer ceramic capacitor 210 according to the second modification, as shown in FIG. 8, the plated layer 28 of the external electrode 24 includes a single plated layer.

The plated layer 28 is, for example, preferably a Sn plated layer. With such a configuration, it is possible to improve the solder wettability at the time of mounting the multilayer ceramic capacitor 210, which facilitates the mounting.

According to the multilayer ceramic capacitor 210 of the second modification shown in FIG. 8, it is possible to obtain the same or substantially the same advantageous effects as those of the multilayer ceramic capacitor 10 of FIG. 1.

### (3) Third Modification

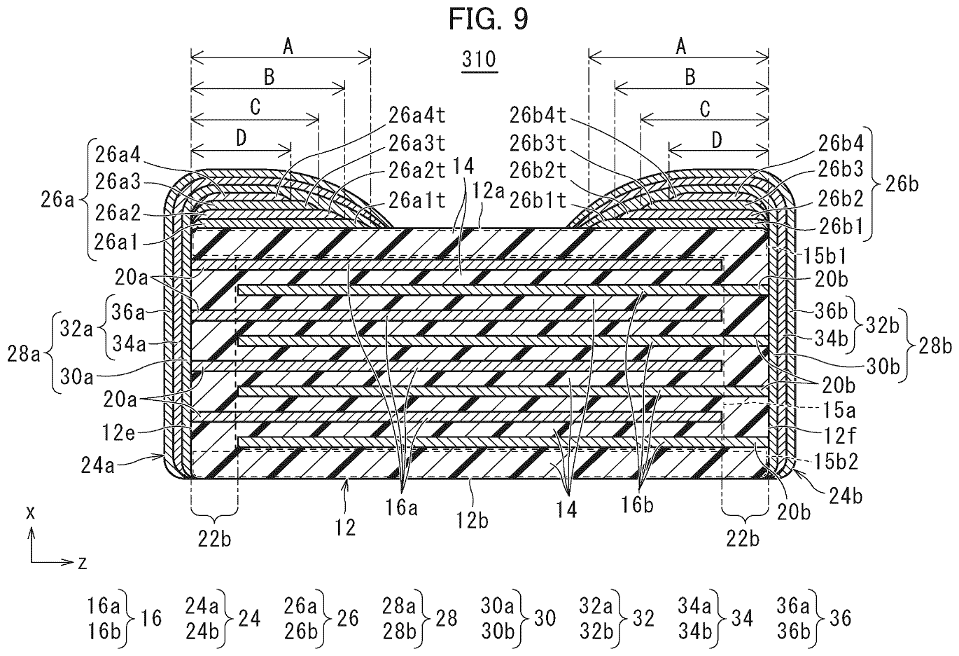

Next, a multilayer ceramic capacitor 310, which is a multilayer ceramic capacitor according to a third modification of the first example embodiment of the present invention, will be described. FIG. 9 is a schematic cross-sectional view showing a multilayer ceramic capacitor as an example of a multilayer ceramic capacitor according to a third modification of the first example embodiment of the present invention. The same components as those in FIGS. 1 to 6 are denoted by the same reference numerals, and detailed descriptions thereof will be omitted.

In the multilayer ceramic capacitor 310 according to the third modification, as shown in FIG. 9, in the first external electrode 24a, the first base electrode layer 26a is provided only on a portion of the first main surface 12a of the multilayer body 12, and the first plated layer 28a covers the first base electrode layer 26a and is provided on the surface of the first end surface 12e of the multilayer body 12 and on a portion of the first main surface 12a. In this case, the first external electrode 24a is electrically connected to the first extension electrode portions 20a of the first internal electrode layers 16a via the first plated layer 28a.

Similarly, in the second external electrode 24b, the second base electrode layer 26b is provided only on a portion of the first main surface 12a of the multilayer body 12, and the second plated layer 28b covers the second base electrode layer 26b and is provided on the surface of the second end surface 12f of the multilayer body 12 and a portion of the first main surface 12a. In this case, the second external electrode 24b is electrically connected to the second extension electrode portions 20b of the second internal electrode layers 16b via the second plated layer 28b.

That is, in the present modification, the plated layer 28 is a direct plated layer provided directly on the surface of the multilayer body 12.

In the present modification, similarly to the multilayer ceramic capacitor 10 of FIG. 1, the plated layer 28 defining and functioning as a direct plated layer includes a lower plated layer 30 and an upper plated layer 32, and the upper plated layer 32 further includes a two-layer configuration including an intermediate plated layer 34 and an upper plated layer 36.

In such a case, the plated layer 28 may be directly formed as a plated layer after the catalyst is provided on the surface of the multilayer body 12 as a pretreatment.

The plated layer 28 defining and functioning as a direct plated layer preferably includes, for example, at least one metal of Cu, Ni, Sn, Pb, Au, Ag, Pd, Bi, or Zn, or an alloy including the metal. For example, in a case where the first internal electrode layers 16a and the second internal electrode layers 16b are provided using Ni, in the plated layer 28 defining and functioning as a direct plated layer, it is preferable that each of the first lower plated layer 30a and the second lower plated layer 30b of the lower plated layers 30 directly connected respectively to the first extension electrode portions 20a of the first internal electrode layers 16a and the second extension electrode portions 20b of the second internal electrode layers 16b is provided using Cu, which has a good bonding property with Ni.

Similar to the multilayer ceramic capacitor 10 of FIG. 1, the upper plated layer 32 preferably includes, for example, a two-layer configuration of an intermediate plated layer 34, which is a Ni plated layer, and an upper plated layer 36, which is a Sn plated layer.

The thickness per layer of the plated layer 28 defining and functioning as a direct plated layer is, for example, preferably about 1 μm or more and about 6 μm or less.

Each plated layer of the plated layer 28 as a direct plated layer preferably does not include glass. The metal ratio per unit volume of the plated layer is, for example, preferably about 99% by volume or more.

According to the multilayer ceramic capacitor 310 of the third modification shown in FIG. 9, in addition to the same or substantially the same advantageous effects as those of the multilayer ceramic capacitor 10 of FIG. 1, the following advantageous effects are achieved. That is, since each of the first main surface electrode portion 26a1, the second main surface electrode portion 26a2, the third main surface electrode portion 26a3, and the fourth main surface electrode portion 26a4 of the first base electrode layer 26a and each of the first main surface electrode portion 26b1, the second main surface electrode portion 26b2, the third main surface electrode portion 26b3, and the fourth main surface electrode portion 26b4 of the second base electrode layer 26b are not provided on the first end surface 12e nor the second end surface 12f, it is possible to reduce the size of the L dimension in the length direction z such that it is possible to reduce the dimensions of the multilayer ceramic capacitor.

### (4) Fourth Modification

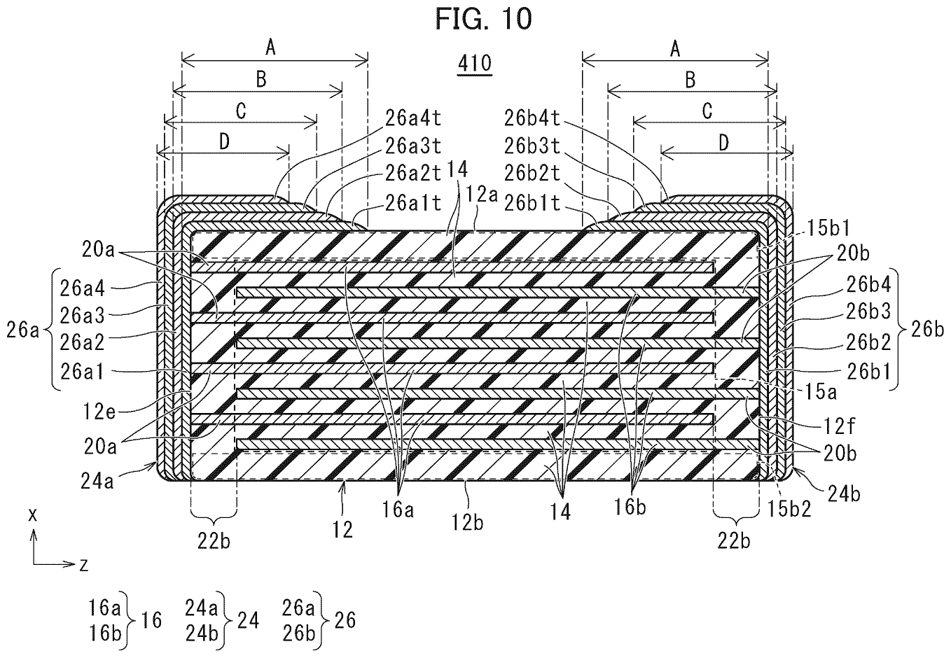

Next, a multilayer ceramic capacitor 410, which is a multilayer ceramic capacitor according to a fourth modification of the first example embodiment of the present invention, will be described. FIG. 10 is a schematic cross-sectional view showing a multilayer ceramic capacitor as an example of a multilayer ceramic capacitor according to a fourth modification of the first example embodiment of the present invention. The same components as those in FIGS. 1 to 6 are denoted by the same reference numerals, and detailed descriptions thereof will be omitted.

As shown in FIG. 10, in the multilayer ceramic capacitor 410 according to the fourth modification, in the configuration of the multilayer ceramic capacitor 10 of FIG. 1, the first external electrode 24a does not include any plated layer and includes only the first main surface electrode portion 26a1 to the fourth main surface electrode portion 26a4, and the second external electrode 24b does not include any plated layer and includes only the first main surface electrode portion 26b1 to the fourth main surface electrode portion 26b4.

According to the multilayer ceramic capacitor 410 of the fourth modification shown in FIG. 10, in addition to the same or substantially the same advantageous effects as those of the multilayer ceramic capacitor 10 of FIG. 1, the following advantageous effects are achieved. That is, by providing the external electrode 24 without any plated layer and only with the first main surface electrode portion 26a1 to the fourth main surface electrode portion 26a4 and the first main surface electrode portion 26b1 to the fourth main surface electrode portion 26b4, which define and function as base electrode layers, it is possible to reduce the size of the multilayer ceramic capacitor by reducing the size of the T dimension in the height direction x such that it is possible to reduce the size of the L dimension in the length direction z.

In the multilayer ceramic capacitor 310 according to the fourth modification shown in FIG. 10, the fourth main surface electrode portion 26a4 of the first base electrode layer 26a and the fourth main surface electrode portion 26b4 of the second base electrode layer 26b each define and function as the outermost layers, and are each exposed on the surface of the multilayer ceramic capacitor 10. Therefore, when the fourth main surface electrode portion 26a4 and the fourth main surface electrode portion 26b4 are oxidized, for example, in a state where these main surface electrode portions are exposed on the surface, the solder does not spread to the fourth end portion 26a4t and the fourth end portion 26b4t adjacent to the middle of the multilayer body 12 at the time of mounting the multilayer ceramic capacitor 10. This makes it possible to reduce or prevent short-circuit failure.

### 2. Method of Manufacturing Multilayer Ceramic Capacitor

Hereinafter, an example of a method of manufacturing a multilayer ceramic capacitor, which is an example of the multilayer ceramic capacitor according to the first example embodiment, will be described.

First, a dielectric sheet and an electrically conductive paste for manufacturing internal electrodes are prepared. The dielectric sheet and the electrically conductive paste for manufacturing the internal electrode layers include a binder (for example, a known organic binder) and an organic solvent (for example, a known organic binder).

Next, the electrically conductive paste for manufacturing internal electrodes is printed on the dielectric sheet in a predetermined pattern by, for example, screen printing or gravure printing to form an internal electrode pattern. As for the dielectric sheet, a dielectric sheet for manufacturing an outer layer on which an internal electrode pattern is not printed is also prepared.

A predetermined number of outer layer dielectric sheets on which no internal electrode pattern is formed are laminated. On the resultant product, a dielectric sheet on which an internal electrode pattern corresponding to the first internal electrode layer 16a is formed and a dielectric sheet on which an internal electrode pattern corresponding to the second internal electrode layer 16b is formed are alternately laminated. Then, on the resultant product, a predetermined number of outer layer dielectric sheets on which no internal electrode pattern is formed are laminated, such that a multilayer sheet is manufactured.

Further, the multilayer sheet is pressed in the lamination direction by, for example, isostatic pressing or the like to prepare a multilayer block.

Subsequently, the multilayer block is cut into a predetermined size to cut out multilayer chips. Thereafter, for example, wet barrel polishing may be performed to round the corner portions and ridge portions of each of the multilayer chips.

Next, each of the multilayer chips is fired to produce the multilayer body 12. The firing temperature is, for example, preferably about 900° C. or more and about 1400° C. or less depending on the ceramic or the material of the internal electrode layers 16.

Subsequently, the base electrode layers 26 including the first to fourth main surface electrode portions are formed on the first end surface 12e, the second end surface 12f, a portion of the first main surface 12a, and a portion of the second main surface 12b of the multilayer body 12.

Each of the first to fourth main surface electrode portions is formed by, for example, a sputtering method or screen printing.

When each of the first to fourth main surface electrode portions is formed by a sputtering method, for example, the following steps are performed.
(1-1) A sputtered film is formed on the entire or substantially the entire surface of the multilayer body 12.
(1-2) Next, portions of the sputtered film to remain as the first main surface electrode portion 26a1 and the first main surface electrode portion 26b1 of the first main surface electrode portion, specifically, a portion of the first main surface 12a, and the first end surface 12e and the second end surface 12f of the multilayer body 12 are covered with a mask made of a resin, for example.
(1-3) Next, the sputtered film is dissolved by an etching solution. As a result, the sputtered film other than the portion covered with the mask made of resin is removed from the multilayer body 12.
(1-4) Next, the resin mask is dissolved in an organic solvent. As a result, only the sputtered film corresponding to the mask of the resin remains on the multilayer body 12, and the sputtered film forms the first main surface electrode portion 26a1 and the first main surface electrode portion 26b1 of the first main surface electrode portion.
(1-5) Next, on the first main surface 12a of the multilayer body 12, portions exposed between the first main surface electrode portion 26a1 and the first main surface electrode portion 26b1 of the first main surface electrode portion and portions of the first main surface electrode portion 26a1 and the first main surface electrode portion 26b1 formed in the step (1-4) corresponding to the first end portion 26a1t and the first end portion 26b1t on the first main surface 12a are covered with a mask made of a resin.
(1-6) Next, as the surface of the multilayer body 12, a further sputtered film is formed on the surface of the sputtered film obtained in the step (1-4) and the surface of the mask obtained in the step (1-5).
(1-7) Next, on the sputtered film obtained in the step (1-6), portions to remain as the second main surface electrode portion 26a2 and the second main surface electrode portion 26b2, more specifically, portions corresponding to a portion of the first main surface 12a, and the first end surface 12e and the second end surface 12f of the multilayer body 12, are covered with a mask made of a resin, for example. In addition, the mask in this step is formed so that the length along the direction connecting between the end portion of the first main surface electrode portion of the base electrode layer of the multilayer body 12 adjacent to the middle of the multilayer body and the surface of the multilayer body 12 where the first internal electrode layers are exposed is shorter than the resultant product formed in the step (1-2).
(1-8) Next, the sputtered film obtained in the step (1-6) is dissolved with an etching solution. As a result, the sputtered film other than the portion covered with the mask made of resin is removed from the multilayer body 12.
(1-9) Next, the resin mask obtained in the step (1-5) and the step (1-7) is dissolved in an organic solvent. As a result, only the sputtered film corresponding to the mask of the resin remains on the multilayer body 12, and the sputtered film forms the second main surface electrode portion 26a2 and the second main surface electrode portion 26b2.
(1-10) Thereafter, the steps (1-5) to (1-9) are repeated to sequentially form the third main surface electrode portion and the fourth main surface electrode portion. In addition, the mask in the step (1-5) in a case of sequentially forming the third main surface electrode portion and the fourth main surface electrode portion is formed so that the length along the direction connecting between the end portion of the first main surface electrode portion of the base electrode layer of the multilayer body 12 adjacent to the middle of the multilayer body and the surface of the multilayer body 12 where the first internal electrode layers are exposed is longer than the resultant product formed in the previous step (1-5).

With such a configuration, as in the multilayer ceramic capacitor 10 shown in FIG. 4, when the length of the first main surface electrode portion 26a1 is defined as length A, the length of the second main surface electrode portion 26a2 is defined as length B, the length of the third main surface electrode portion 26a3 is defined as length C, and the length of the fourth main surface electrode portion 26a4 is defined as length D, the relationship of length A>length B>length C>length D can be obtained. Similarly, when the length of the first main surface electrode portion 26b1 is defined as length A, the length of the second main surface electrode portion 26b2 is defined as length B, the length of the third main surface electrode portion 26b3 is defined as length C, and the length of the fourth main surface electrode portion 26b4 is defined as length D, the relationship of length A>length B>length C>length D can be obtained.

In addition, as in the multilayer ceramic capacitor 310 shown in FIG. 9, when the base electrode layer 26 including the first main surface electrode portion, the second main surface electrode portion, the third main surface electrode portion, and the fourth main surface electrode portion is formed only on the first main surface 12a, the resin masks obtained in the step (1-2) and the step (1-7) are formed so as not to cover the first end surface 12e and the second end surface 12f of the multilayer body 12.

In an example where each of the first to fourth main surface electrode portions is formed by screen printing, the following steps are performed. That is, the printing plate is changed for each main surface electrode of each layer, and a printing pattern corresponding to the shape of a desired main surface electrode portion is formed at a desired position of the multilayer body 12.

At this time, the opposing interval of the pair of print patterns formed on the first main surface 12a of the multilayer body 12 is formed such that, among a case of forming the first main surface electrode portion, a case of forming the second main surface electrode portion, a case of forming the third main surface electrode portion, and a case of forming the fourth main surface electrode portion, the length along the direction connecting between the end portion of the first main surface electrode portion of the base electrode layer adjacent to the middle of the multilayer body and the surface of the multilayer body 12 where the first internal electrode layers are exposed is longer for the earlier formed main surface electrode portions than the later formed main surface electrode portions.

As a result, in the same or substantially the same manner as in the case where the multilayer ceramic capacitor is formed by the sputtering method, it is possible to obtain the configuration of the first to fourth main surface electrode portions as in the multilayer ceramic capacitor 10 shown in FIG. 4.

Thereafter, a plated layer 28 is formed on the surface of the fourth main surface electrode portion of the base electrode layer 26. The plated layer 28 is formed by barrel plating, for example. As in the multilayer ceramic capacitor 10 shown in FIG. 4, when the plated layer 28 includes the lower plated layer 30 and the upper plated layer 32, the respective plated layers are sequentially formed by barrel plating, for example.

In addition, for example, as in the multilayer ceramic capacitor 310 shown in FIG. 9, when the plated layer 28 is directly formed as a plated layer, the following process is performed. That is, plating is performed on the first end surface 12e and the second end surface 12f of the multilayer body 12, and a plating film is directly formed on the exposed portions of the first extension electrode portions 20a and the second extension electrode portions 20b of the internal electrode layers 16. When plating is performed, either electrolytic plating or electroless plating may be used, but electroless plating requires pretreatment with a catalyst or the like in order to improve the plating deposition rate, and has the disadvantage of complicating the process. Therefore, in general, electrolytic plating is preferably used. As the plating method, for example, barrel plating is preferably used. In addition, if necessary, the plated layer 28 defining and functioning as a direct plated layer may include a plurality of layers as in the multilayer ceramic capacitor 10 shown in FIG. 9, for example, and the upper plating electrode formed on the surface of the lower plating electrode may be formed in the same or substantially the same manner.

As described above, it is possible to manufacture the multilayer ceramic capacitor 10 shown in FIG. 1.

According to the example of the method of manufacturing the multilayer ceramic capacitor according to the present example embodiment described above, the end portions of the first to fourth main surface electrode portions formed on the first main surface of the multilayer body are provided so as not to be aligned with one another, such that locations where stress is generated are dispersed, and it is possible to reduce or prevent cracks from extending from the tip of the external electrode to the interior of the multilayer ceramic capacitor.

### B. Second Example Embodiment

### 1. Multilayer Ceramic Capacitor

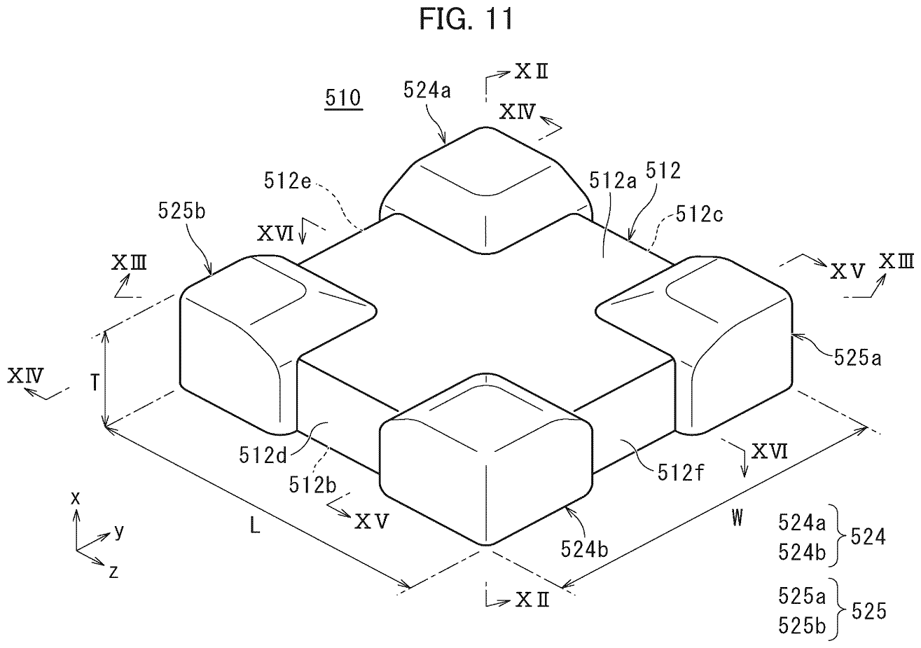

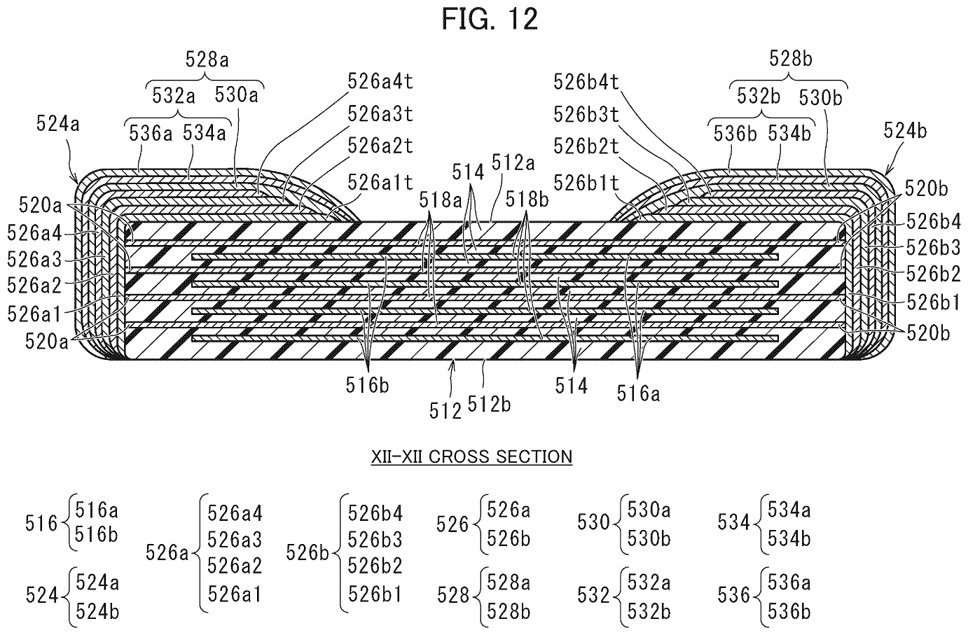

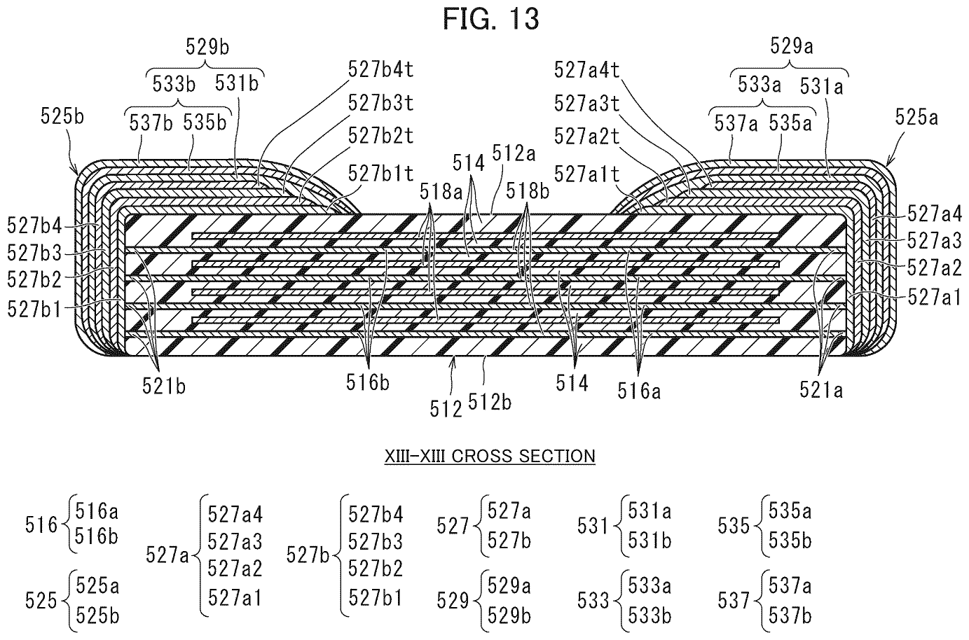

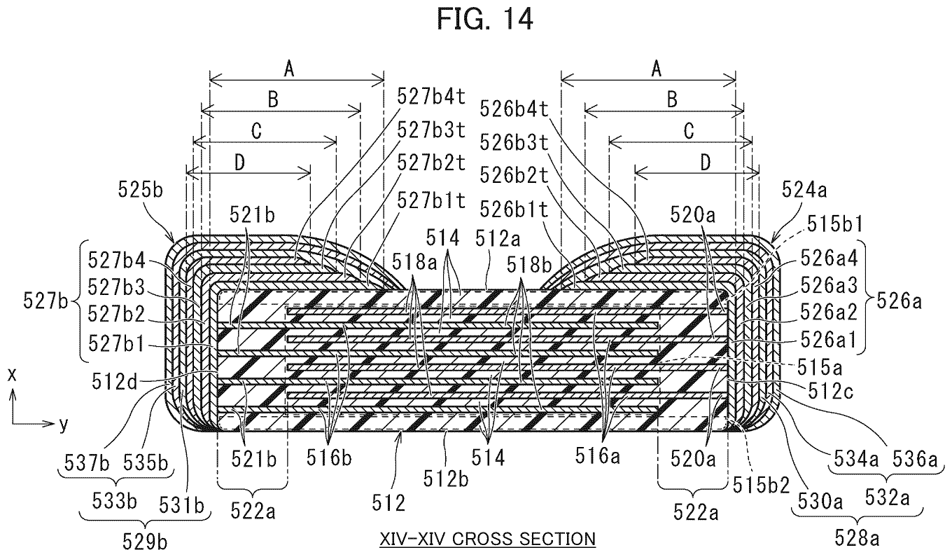

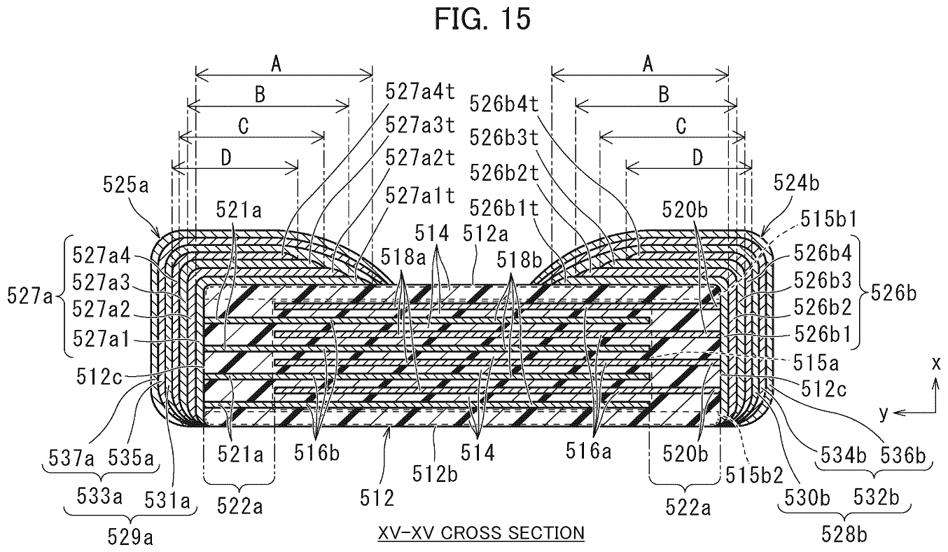

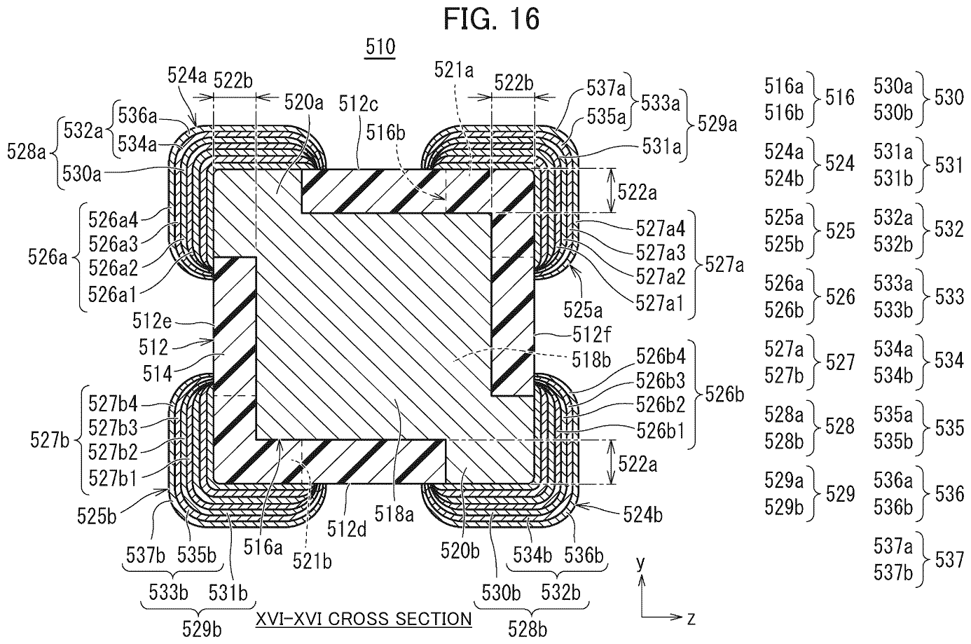

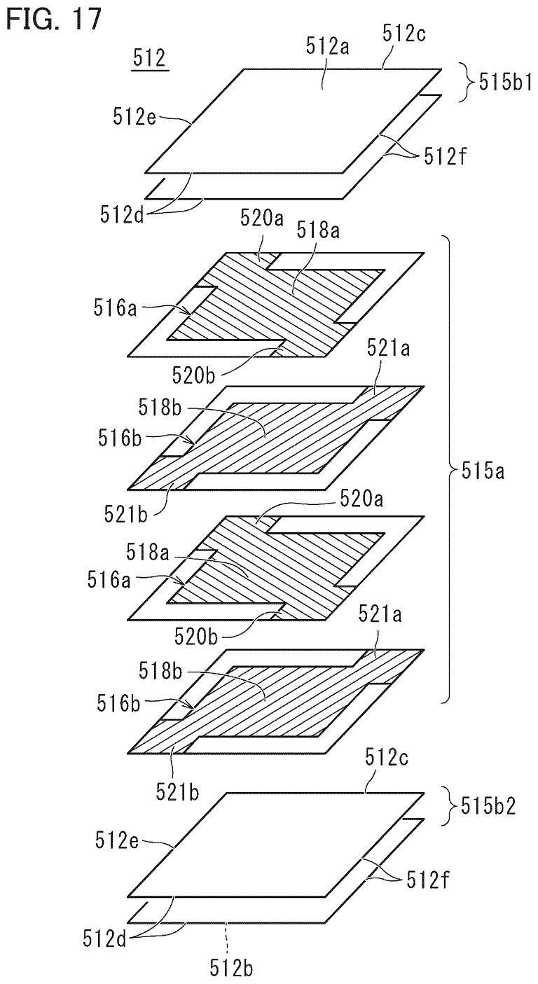

Next, a multilayer ceramic capacitor according to a second example embodiment of the present invention will be described. FIG. 11 is an external perspective view showing a multilayer ceramic capacitor as an example of a multilayer ceramic electronic component according to a second example embodiment of the present invention. FIG. 12 is a schematic cross-sectional view taken along the line XII-XII in FIG. 11. FIG. 13 is a schematic cross-sectional view taken along the line XIII-XIII in FIG. 11. FIG. 14 is a schematic cross-sectional view taken along the line XIV-XIV in FIG. 11. FIG. 15 is a schematic cross-sectional view taken along the line XV-XV in FIG. 11. FIG. 16 is a schematic cross-sectional view taken along the line XVI-XVI in FIG. 11. FIG. 17 is an exploded perspective view of the multilayer body shown in FIG. 1.

A multilayer ceramic capacitor 510 includes a multilayer body 512 and external electrodes 524 and 525.

### Multilayer Body

The multilayer body 512 includes a plurality of ceramic layers 514 and a plurality of internal electrode layers 516. The multilayer body 512 includes a first main surface 512a and a second main surface 512b opposed to each other in the height direction x, a first lateral surface 512c and a second lateral surface 512d opposed to each other in the width direction y orthogonal or substantially orthogonal to the height direction x, and a third lateral surface 512e and a fourth lateral surface 512f opposed to each other in the length direction z orthogonal or substantially orthogonal to the height direction x and the width direction y. The first main surface 512a and the second main surface 512b extend along the width direction y and the length direction z, respectively. The first lateral surface 512c and the second lateral surface 512d extend along the height direction x and the length direction z, respectively. The third lateral surface 512e and the fourth lateral surface 512f extend along the height direction x and the width direction y, respectively. Accordingly, the height direction x refers to a direction connecting between the first main surface 512a and the second main surface 512b, the width direction y refers to a direction connecting between the first lateral surface 512c and the second lateral surface 512d, and the length direction z refers to a direction connecting between the third lateral surface 512e and the fourth lateral surface 512f.

Further, the multilayer body 512 preferably includes rounded corner portions and rounded ridge portions. Here, the corner portions each refer to a portion where three surfaces of the multilayer body 512 intersect with one another, and the ridge portions each refer to a portion where two surfaces of the multilayer body 512 intersect with each other.

As shown in FIGS. 14 and 15, the multilayer body 512 includes an effective layer portion 515a in which the plurality of internal electrode layers 516 are opposed to each other in the height direction x connecting between the first main surface 512a and the second main surface 512b, a first outer layer portion 515b1 including the plurality of ceramic layers 514 located between the internal electrode layer 516 located closest to the first main surface 512a and the first main surface 512a, and a second outer layer portion 515b2 including the plurality of ceramic layers 514 located between the internal electrode layer 516 located closest to the second main surface 512b and the second main surface 512b.

The first outer layer portion 515b1 is an aggregate including the plurality of ceramic layers 514 located adjacent to the first main surface 512a of the multilayer body 512 and located between the first main surface 512a and the internal electrode layer 516 closest to the first main surface 512a.

The second outer layer portion 515b2 is an aggregate including the plurality of ceramic layers 514 located adjacent to the second main surface 512b of the multilayer body 512 and located between the second main surface 512b and the internal electrode layer 516 closest to the second main surface 512b.

The effective layer portion 515a is sandwiched between the first outer layer portion 515b1 and the second outer layer portion 515b2.

The ceramic layer 514 can be made of, for example, a dielectric material. As the dielectric material, for example, a dielectric ceramic including a main component such as BaTiO₃, CaTiO₃, SrTiO₃, or CaZrO₃ can be used. In addition, in accordance with desired characteristics of the multilayer body, for example, a subcomponent having a smaller content than the main component such as a Mn compound, a Fe compound, a Cr compound, a Co compound, or a Ni compound may be added.

The ceramic layer 514 may include a plurality of crystal grains including, for example, a perovskite compound having BaTiO₃ as a basic structure.

As the thickness of the ceramic layer 514 is smaller, the capacitance of a capacitor becomes larger. Therefore, the crystal grain size is, for example, preferably 1 μm or less.

### Internal Electrode Layer

As shown in FIGS. 12 to 17, the internal electrode layer 516 includes the plurality of first internal electrode layers 516a and the plurality of second internal electrode layers 516b. The first internal electrode layers 516a and the second internal electrode layer 516b are alternately laminated with a corresponding one of the ceramic layers 514 interposed therebetween.

Each of the first internal electrode layers 516a is provided on the surface of a corresponding one of the ceramic layers 514. Further, the first internal electrode layers 516a each include a first counter electrode portion 518a which is opposed to the first main surface 512a and the second main surface 512b and opposed to the second internal electrode layer 516b, and are laminated in a direction connecting between the first main surface 512a and the second main surface 512b.

In addition, each of the second internal electrode layers 516b is provided on a surface of the ceramic layer 514 different from that of the ceramic layer 514 on which the first internal electrode layer 516a is provided. The second internal electrode layers 516b each include a second counter electrode portion 518b opposed to the first main surface 512a and the second main surface 512b, and are laminated in a direction connecting between the first main surface 512a and the second main surface 512b.

As shown in FIGS. 12 to 17, each of the first internal electrode layers 516a includes a first extension electrode portion 520a which extends toward the first lateral surface 512c and the third lateral surface 512e of the multilayer body 512, and includes a second extension electrode portion 520b which extends toward the second lateral surface 512d and the fourth lateral surface 512f of the multilayer body 512. In addition, the width of the first extension electrode portion 520a exposed at the first lateral surface 512c may be equal or substantially equal to the width of the first extension electrode portion 520a exposed at the third lateral surface 512e, and the width of the second extension electrode portion 520b exposed at the second lateral surface 512d may be equal or substantially equal to the width of the second extension electrode portion 520b exposed at the fourth lateral surface 512f.

That is, the first extension electrode portion 520a extends toward the third lateral surface 512e of the multilayer body 512, and the second extension electrode portion 520b extends toward the fourth lateral surface 512f of the multilayer body 512. In addition, the first extension electrode portion 520a may be exposed only at the third lateral surface 512e, and the second extension electrode portion 520b may be exposed only at the fourth lateral surface 512f.

Each of the second internal electrode layers 516b includes a third extension electrode portion 521a that extends toward the first lateral surface 512c and the fourth lateral surface 512f of the multilayer body 512, and includes a fourth extension electrode portion 521b that extends toward the second lateral surface 512d and the third lateral surface 512e of the multilayer body 512. The width of the third extension electrode portion 521a exposed at the first lateral surface 512c may be equal or substantially equal to the width of the third extension electrode portion 521a exposed at the fourth lateral surface 512f, and the width of the fourth extension electrode portion 521b exposed at the second lateral surface 512d may be equal or substantially equal to the width of the fourth extension electrode portion exposed at the third lateral surface 512e.

That is, the third extension electrode portion 521a extends adjacent to and is exposed on the fourth lateral surface 512f of the multilayer body 512, and the fourth extension electrode portion 521b extends adjacent to and is exposed on the third lateral surface 512e of the multilayer body 512. In addition, the third extension electrode portion 521a may be exposed only at the fourth lateral surface 512f, and the fourth extension electrode portion 521b may be exposed only at the third lateral surface 512e.

When the multilayer ceramic capacitor 510 is viewed from the lamination direction, it is preferable that a straight line connecting between the first extension electrode portion 520a and the second extension electrode portion 520b of the first internal electrode layer 516a intersects a straight line connecting between the third extension electrode portion 521a and the fourth extension electrode portion 521b of the second internal electrode layer 516b.

Further, in the first lateral surface 512c, the second lateral surface 512d, the third lateral surface 512e, and the fourth lateral surface 512f of the multilayer body 512, it is preferable that the first extension electrode portion 520a of the first internal electrode layer 516a and the fourth extension electrode portion 521b of the second internal electrode layer 516b extend toward the positions opposed to each other, and the second extension electrode portion 520b of the first internal electrode layer 516a and the third extension electrode portion 521a of the second internal electrode layer 516b extend toward the positions opposed to each other.

In addition, as shown in FIG. 16, the multilayer body 512 includes lateral portions (W gap) 522a of the multilayer body 512 provided between one end of the first counter electrode portion 518a in the width direction y and the first lateral surface 512c and between the other end of the second counter electrode portion 518b in the width direction y and the second lateral surface 512d.

Further, as shown in FIG. 16, the multilayer body 512 includes lateral portions (L gap) 522b of the multilayer body 512 provided between one end of the first counter electrode portion 518a in the length direction z and the third lateral surface 512e and between the other end of the second counter electrode portion 518b in the length direction z and the fourth lateral surface 512f.

Each of the internal electrode layers 516 can be made of, for example, a metal such as Ni, Cu, Ag, Pd, or Au, or an appropriate electrically conductive material such as an alloy including at least one of these metals such as an Ag—Pd alloy, but is not limited thereto.

### External Electrode

As shown in FIGS. 11 to 16, the external electrodes 524 and 525 are provided on the multilayer body 512.

Each of the external electrodes 524 includes a base electrode layer 526 and a plated layer 528 that covers the base electrode layer 526.

Each of the external electrodes 525 includes a base electrode layer 527 and a plated layer 529 that covers the base electrode layer 527.

The external electrodes 524 include a first external electrode 524a and a second external electrode 524b.

The first external electrode 524a covers the first extension electrode portions 520a on the first lateral surface 512c and the third lateral surface 512e, and covers a portion of the first main surface 512a. The first external electrode 524a is electrically connected to the first extension electrode portions 520a of the first internal electrode layers 516a.

The second external electrode 524b covers the second extension electrode portions 520b on the second lateral surface 512d and the fourth lateral surface 512f, and covers a portion of the first main surface 512a. The second external electrode 524b is electrically connected to the second extension electrode portions 520b of the first internal electrode layers 516a.

The external electrodes 525 include a third external electrode 525a and a fourth external electrode 525b.

The third external electrode 525a covers the third extension electrode portions 521a on the first lateral surface 512c and the fourth lateral surface 512f, and covers a portion of the first main surface 512a. The third external electrode 525a is electrically connected to the third extension electrode portions 521a of the second internal electrode layer 516b.

The fourth external electrode 525b covers the fourth extension electrode portions 521b on the second lateral surface 512d and the third lateral surface 512e, and covers a portion of the first main surface 512a. The fourth external electrode 525b is electrically connected to the fourth extension electrode portions 521b of the second internal electrode layer 516b.

In the multilayer body 512, the first counter electrode portions 518a of the first internal electrode layers 516a and the second counter electrode portions 518b of the second internal a electrode layers 516b are opposed to each other with corresponding one of the ceramic layers 514 interposed therebetween, such that capacitance is generated. Thus, capacitance can be obtained between the first external electrode 524a and the second external electrode 524b to which the first internal electrode layers 516a are connected and the third external electrode 525a and the fourth external electrode 525b to which the second internal electrode layers 516b are connected, such that characteristics of the capacitor are provided.

### Base Electrode Layer

The base electrode layers 526 includes a first base electrode layer 526a and a second base electrode layer 526b. The base electrode layer 527 includes a third base electrode layer 527a and a fourth base electrode layer 527b.

Each of the first base electrode layer 526a, the second base electrode layer 526b, the third base electrode layer 527a, and the fourth base electrode layer 527b includes a first main surface electrode portion, a second main surface electrode portion, a third main surface electrode portion, and a fourth main surface electrode portion. Specifically, the first base electrode layer 526a has a configuration in which a first main surface electrode portion 526a1, a second main surface electrode portion 526a2, a third main surface electrode portion 526a3, and a fourth main surface electrode portion 526a4 are laminated. The second base electrode layer 526b has a configuration in which a first main surface electrode portion 526b1, a second main surface electrode portion 526b2, a third main surface electrode portion 526b3, and a fourth main surface electrode portion 526b4 are laminated. The third base electrode layer 527a has a configuration in which a first main surface electrode portion 527al, a second main surface electrode portion 527a2, a third main surface electrode portion 527a3, and a fourth main surface electrode portion 527a4 are laminated. The fourth base electrode layer 527b has a configuration in which a first main surface electrode portion 527b1, a second main surface electrode portion 527b2, a third main surface electrode portion 527b3, and a fourth main surface electrode portion 527b4 are laminated.

### Main Surface Electrode Portion

As shown in FIGS. 12 and 14, the first main surface electrode portion 526a1 is provided on the surface of the multilayer body 512, the second main surface electrode portion 526a2 is provided on the surface of first main surface electrode portion 526al, the third main surface electrode portion 526a3 is provided on the surface of second main surface electrode portion 526a2, and the fourth main surface electrode portion 526a4 is provided on the surface of third main surface electrode portion 526a3.

Here, as shown in FIG. 14, on the first main surface 512a, a direction is defined which connects between an end portion of the first main surface electrode portion of the first base electrode layer adjacent to the middle and a surface on which the first internal electrode layers are exposed at the surface of the multilayer body. More specifically, a direction (hereinafter, referred to as a third reference direction) is defined which connects between a first end portion 526a1t of the first main surface electrode portion 526a1 of the first base electrode layer 526a adjacent to the middle of the multilayer body 512 and a first lateral surface 512c of the multilayer body 512 at which the first extension electrode portions 520a of the first internal electrode layers 516a are exposed. When the length of the first main surface electrode portion 526a1 in the third reference direction is defined as length A, the length of the second main surface electrode portion 526a2 in the same direction as the length A is defined as length B, the length of the third main surface electrode portion 526a3 in the same direction as the length A is defined as length C, and the length of the fourth main surface electrode portion 526a4 in the same direction as the length A is defined as length D, the relationship of length A>length B>length C>length D is satisfied.

Although not shown, the relationship among the lengths of the first main surface electrode portion 526al, the second main surface electrode portion 526a2, the third main surface electrode portion 526a3, and the fourth main surface electrode portion 526a4 of the first base electrode layer 526a is the same or substantially the same as the configuration shown in FIG. 14 in the LT cross-sectional view.

With such a configuration, on the first main surface 512a, since the first main surface electrode portion 526al, the second main surface electrode portion 526a2, the third main surface electrode portion 526a3, and the fourth main surface electrode portion 526a4 of the first base electrode layer 526a are not aligned with one another at the first end portion 526a1t, the second end portion 526a2t, the third end portion 526a3t, and the fourth end portion 526a4t adjacent to the middle of the multilayer body 512, it is possible to disperse the stress, generated at the time of solder shrinkage, of the first external electrode 524a to the middle of the multilayer body 512.

Further, on the first main surface 512a, a direction is defined which connects between the end portion of the first main surface electrode portion of the fourth base electrode layer adjacent to the middle of the multilayer body and the surface of the multilayer body where the second internal electrode layers are exposed. More specifically, a direction (hereinafter, referred to as a fourth reference direction) is defined which connects between the first end portion 527b1t of the first main surface electrode portion 527b1 of the fourth base electrode layer 527b adjacent to the middle of the multilayer body 512 and the third lateral surface 512e of the multilayer body 512 where the second extension electrode portions 520b of the second internal electrode layers 516b are exposed. When the length of the first main surface electrode portion 527b1 in the fourth reference direction is defined as length A, the length of the second main surface electrode portion 527b2 in the same direction as the length A is defined as length B, the length of the third main surface electrode portion 527b3 in the same direction as the length A is defined as length C, and the length of the fourth main surface electrode portion 527b4 in the same direction as the length A is defined as length D, the relationship of length A>length B>length C>length D is satisfied.

Although not shown, the relationship among the lengths of the first main surface electrode portion 527b1, the second main surface electrode portion 527b2, the third main surface electrode portion 527b3, and the fourth main surface electrode portion 527b4 of the fourth base electrode layer 527b is the same or substantially the same as the configuration shown in FIG. 14 in the LT cross-sectional view.

With such a configuration, on the first main surface 512a, since the first main surface electrode portion 527b1, the second main surface electrode portion 527b2, the third main surface electrode portion 527b3, and the fourth main surface electrode portion 527b4 of the fourth base electrode layer 527b are not aligned with one another at the first end portion 527b1t, the second end portion 527b2t, the third end portion 527b3t, and the fourth end portion 527b4t adjacent to the middle of the multilayer body 512, it is possible to disperse the stress, generated at the time of solder shrinkage, of the third external electrode 525a to the middle of the multilayer body 512.

Further, as shown in FIG. 15, on the first main surface 512a, a direction is defined which connects between the end portion of the first main surface electrode portion of the second base electrode layer adjacent to the middle of the multilayer body and the surface of the multilayer body where the first internal electrode layers are exposed. More specifically, a direction (hereinafter, referred to as a fifth reference direction) is defined which connects between the first end portion 526b1t of the first main surface electrode portion 526b1 of the second base electrode layer 526b adjacent to the middle of the multilayer body 512 and the fourth lateral surface 512f of the multilayer body 512 where the first extension electrode portions 520a of the first internal electrode layers 516a are exposed. When the length of the first main surface electrode portion 526b1 in the fifth reference direction is defined as length A, the length of the second main surface electrode portion 526b2 in the same direction as the length A is defined as length B, the length of the third main surface electrode portion 526b3 in the same direction as the length A is defined as length C, and the length of the fourth main surface electrode portion 526b4 in the same direction as the length A is defined as length D, the relationship of length A>length B>length C>length D is satisfied.

Although not shown, the relationship among the lengths of the first main surface electrode portion 526b1, the second main surface electrode portion 526b2, the third main surface electrode portion 526b3, and the fourth main surface electrode portion 526b4 of the second base electrode layer 526b is the same or substantially the same as the configuration shown in FIG. 15 in the LT cross-sectional view.

With such a configuration, on the first main surface 512a, since the first main surface electrode portion 526b1, the second main surface electrode portion 526b2, the third main surface electrode portion 526b3, and the fourth main surface electrode portion 526b4 of the second base electrode layer 526b are not aligned with one another at the first end portion 526b1t, the second end portion 526b2t, the third end portion 526b3t, and the fourth end portion 526b4t adjacent to the middle of the multilayer body 512, it is possible to disperse the stress, generated at the time of solder shrinkage, of the second external electrode 524b to the middle of the multilayer body 512.

Further, on the first main surface 512a, a direction is defined which connects between the end portion of the first main surface electrode portion of the third base electrode layer adjacent to the middle of the multilayer body and the surface of the multilayer body where the second internal electrode layers are exposed. More specifically, a direction (hereinafter referred to as a sixth reference direction) is defined which connects between the first end portion 527a1t of the first main surface electrode portion 527a1 of the third base electrode layer 527a adjacent to the middle of the multilayer body 512 and the third lateral surface 512e of the multilayer body 512 where the third extension electrode portions 521a of the second internal electrode layers 516b are exposed. When the length of the first main surface electrode portion 527a1 in the sixth reference direction is defined as length A, the length of the second main surface electrode portion 527a2 in the same direction as the length A is defined as length B, the length of the third main surface electrode portion 527a3 in the same direction as the length A is defined as length C, and the length of the fourth main surface electrode portion 527a4 in the same direction as the length A is defined as length D, the relationship of length A>length B>length C>length D is satisfied.

Although not shown, the relationship among the lengths of the first main surface electrode portion 527al, the second main surface electrode portion 527a2, the third main surface electrode portion 527a3, and the fourth main surface electrode portion 527a4 of the third base electrode layer 527a is the same or substantially the same as the configuration shown in FIG. 15 in the LT cross-sectional view.

With such a configuration, on the first main surface 512a, since the first main surface electrode portion 527al, the second main surface electrode portion 527a2, the third main surface electrode portion 527a3, and the fourth main surface electrode portion 527a4 of the third base electrode layer 527a are not aligned with one another at the first end portion 526a1t, the second end portion 526a2t, the third end portion 526a3t, and the fourth end portion 526a4t adjacent to the middle of the multilayer body 512, it is possible to disperse the stress, generated at the time of solder shrinkage, of the fourth external electrode 525b to the middle of the multilayer body 512.

In addition, in the third reference direction and the direction orthogonal or substantially orthogonal to the third reference direction along the height direction x, it is preferable that the first end portion 526a1t of the first main surface electrode portion 526a1 is not covered by the second main surface electrode portion 526a2, the second end portion 526a2t of the second main surface electrode portion 526a2 is not covered by the third main surface electrode portion 526a3, and the third end portion 526a3t of the third main surface electrode portion 526a3 is not covered by the fourth main surface electrode portion 526a4.

With such a configuration, since the stress applied to the first end portion 526a1t to the fourth end portion 526a4t of the first main surface electrode portion 526a1 to the fourth main surface electrode portion 526a4 can be concentrated on the outer side of the multilayer body 512 (adjacent to the first lateral surface 512c and the third lateral surface 512e) with respect to these end portions, it is possible to disperse the stress, such that the mechanical strength is improved.

Similarly, it is preferable that, in the fourth reference direction and the direction orthogonal or substantially orthogonal to the fourth reference direction along the height direction x, the first end portion 527b1t of the first main surface electrode portion 527b1 is not covered by the second main surface electrode portion 527b2, the second end portion 527b2t of the second main surface electrode portion 527b2 is not covered by the third main surface electrode portion 527b3, and the third end portion 527b3t of the third main surface electrode portion 527b3 is not covered by the fourth main surface electrode portion 527b4.

With such a configuration, since the stress applied to the first end portion 527b1t to the fourth end portion 527b4t of the first main surface electrode portion 527b1 to the fourth main surface electrode portion 527b4 can be concentrated on the outer side of the multilayer body 512 (adjacent to the second lateral surface 512d and the third lateral surface 512e) with respect to these end portions, it is possible to disperse the stress, such that the mechanical strength is improved.

Further, in the fifth reference direction and the direction orthogonal or substantially orthogonal to the fifth reference direction along the height direction x, it is preferable that the first end portion 527a1t of first main surface electrode portion 527a1 is not covered by the second main surface electrode portion 527a2, the second end portion 527a2t of second main surface electrode portion 527a2 is not covered by the third main surface electrode portion 527a3, and the third end portion 527a3t of the third main surface electrode portion 527a3 is not covered by the fourth main surface electrode portion 527a4.

With such a configuration, since the stress applied to the first end portion 527a1t to the fourth end portion 527a4t of the first main surface electrode portion 527a1 to the fourth main surface electrode portion 527a4 can be concentrated on the outer side of the multilayer body 512 (adjacent to the first lateral surface 512c and the fourth lateral surface 512f) with respect to these end portions, it is possible to disperse the stress, such that the mechanical strength is improved.

Similarly, in the sixth reference direction and the direction orthogonal or substantially orthogonal to the sixth reference direction around the height direction x, it is preferable that the first end portion 526b1t of the first main surface electrode portion 526b1 is not covered by the second main surface electrode portion 526b2, the second end portion 526b2t of the second main surface electrode portion 526b2 is not covered by the third main surface electrode portion 526b3, and the third end portion 526b3t of the third main surface electrode portion 526b3 is not covered by the fourth main surface electrode portion 526b4.

With such a configuration, since the stress applied to the first end portion 526b1t to the fourth end portion 526b4t of the first main surface electrode portion 526b1 to the fourth main surface electrode portion 526b4 can be concentrated on the outer side of the multilayer body 512 (adjacent to the second lateral surface 512d and the fourth lateral surface 512f) with respect to these end portions, it is possible to disperse the stress, such that the mechanical strength is improved.

Further, the fourth main surface electrode portion 526a4 of the first base electrode layer 526a, the fourth main surface electrode portion 526b4 of the second base electrode layer 526b, the fourth main surface electrode portion 527a4 of the third base electrode layer 527a, and the fourth main surface electrode portion 527b4 of the fourth base electrode layer 527b may be exposed on the surface of the multilayer ceramic capacitor 110 as outermost layers. In a state where the fourth main surface electrode portion 526a4, the fourth main surface electrode portion 526b4, the fourth main surface electrode portion 527a4, and the fourth main surface electrode portion 527b4 are exposed on the surface, when the main surface electrode portions are oxidized, for example, the solder does not spread to the fourth end portion 526a4t, 526b4t, 527a4t, and 527b4t adjacent to the middle of the multilayer body 512 at the time of mounting the multilayer ceramic capacitor 110, such that it is possible to reduce or prevent a short circuit defect.

Further, the fourth main surface electrode portion 526a4, the fourth main surface electrode portion 526b4, the fourth main surface electrode portion 527a4, and the fourth main surface electrode portion 527b4 may be covered with a plated layer as shown in FIGS. 12 to 15.

Next, the first to fourth main surface electrode portions defining the base electrode layers 526 and 527 can be formed by, for example, a thin film forming method such as a sputtering method or a vapor deposition method, or by screen printing. However, the details of these methods are the same or substantially the same as those of the first example embodiment, and a detailed description thereof will be omitted.

### Plated Layer

The plated layer 528 includes a first plated layer 528a and a second plated layer 528b.

The first plated layer 528a covers the first main surface electrode portion 526a1 to the fourth main surface electrode portion 526a4 defining and functioning as the first base electrode layer 526a.

The second plated layer 528b covers the first main surface electrode portion 526b1 to the fourth main surface electrode portion 526b4 defining and functioning as the second base electrode layer 526b.

The plated layer 528 includes a plurality of layers. That is, the plated layer 528 includes a lower plated layer 530 and an upper plated layer 532. The lower plated layer 530 includes a first lower plated layer 530a included in the first plated layer 528a and a second lower plated layer 530b included in the second plated layer 528b. The upper plated layer 532 includes a first upper plated layer 532a included in the first plated layer 528a and a second upper plated layer 532b included in the second plated layer 528b.

The first lower plated layer 530a of the lower plated layer 530 covers the fourth main surface electrode portion 526a4 of the first base electrode layer 526a.

The second lower plated layer 530b of the lower plated layer 530 covers the fourth main surface electrode portion 526b4 of the second base electrode layer 526b.

The upper plated layer 532 may include a plurality of layers. In the present example embodiment, for example, the upper plated layer 532 includes a two-layer configuration of an intermediate plated layer 534, which is a Ni plated layer, and an upper plated layer 536, which is a Sn plated layer.

In the upper plated layer 532, the first intermediate plated layer 534a covers the first lower plated layer 530a, and the first upper plated layer 536a covers the first intermediate plated layer 534a. Further, the second intermediate plated layer 534b covers the second lower plated layer 530b, and the second upper plated layer 536b covers the second intermediate plated layer 534b.

The plated layer 529 includes a third plated layer 529a and a fourth plated layer 529b.

The plated layer 529 includes a plurality of layers. That is, the plated layer 529 includes a lower plated layer 531 and an upper plated layer 533. The lower plated layer 531 includes a first lower plated layer 531a included in the third plated layer 529a and a second lower plated layer 531b included in the fourth plated layer 529b. The upper plated layer 533 includes a first upper plated layer 533a included in the third plated layer 529a and a second upper plated layer 533b included in the fourth plated layer 529b.

The first lower plated layer 531a of the lower plated layer 531 covers the fourth main surface electrode portion 527a4 of the third base electrode layer 527a.

The second lower plated layer 531b of the lower plated layer 531 covers the fourth main surface electrode portion 527b4 of the fourth base electrode layer 527b.

The upper plated layer 533 may include a plurality of layers. In the present example embodiment, for example, the upper plated layer 533 includes a two-layer configuration of an intermediate plated layer 535, which is a Ni plated layer, and an upper plated layer 537, which is a Sn plated layer.

In the upper plated layer 533, the first intermediate plated layer 535a covers the first lower plated layer 531a, and the first upper plated layer 537a covers the first intermediate plated layer 535a. Further, the second intermediate plated layer 535b covers the second lower plated layer 531b, and the second upper plated layer 537b covers the second intermediate plated layer 535b.

The lower plated layers 530 and 531 preferably include, for example, at least one metal of Cu, Ni, Sn, Pb, Au, Ag, Pd, Bi, or Zn, or an alloy including the metal. In particular, in the present example embodiment, the lower plated layers 530 and 531 are, for example, preferably Cu plated layers.

It is possible for the intermediate plated layers 534 and 535 defined by Ni plated layers to prevent the lower plated layers 530 and 531 from being eroded by solder when mounting the multilayer ceramic capacitor 110. In addition, it is possible for the upper plated layers 536 and 537 defined by Sn plated layers to improve solder wettability when mounting the multilayer ceramic capacitor 110, which facilitates the mounting. In a case where the plated layers 528 and 529 include a three-layer configuration, in addition to the above configuration, for example, it is preferable to laminate a Sn plated layer, a Ni plated layer, and a Sn plated layer in this order.

Although the ratio of the W dimension to the L dimension of the multilayer ceramic capacitor 510 is, for example, preferably about 0.85 or more and about 1.00 or less, the ratio of the W dimension to the L dimension may assume any other suitable value.

The multilayer ceramic capacitor 510 shown in FIG. 11 including the above-described configuration achieves the same or substantially the same advantageous effects as those of the multilayer ceramic capacitor 10 of the first example embodiment. Further, as in the first example embodiment, the advantageous effects of the present invention are more remarkably provided when the T dimension of the multilayer ceramic capacitor 510 is, for example, about 150 μm or less. Further, when the T-dimension is, for example, about 50 μm or less, the multilayer ceramic capacitor 10 has a reduced thickness, and reliability in mechanical strength becomes more necessary, such that the advantageous effects of the present invention are more remarkably provided.

In the multilayer ceramic capacitor according to the second example embodiment of the present invention, it is preferable that the external electrode 524 and the external electrode 525 of the multilayer ceramic capacitor 510 may have the same first to fourth modifications as the external electrode 24 of the first to fourth modifications of the multilayer ceramic capacitor 10 according to the first example embodiment.

### 2. Method of Manufacturing Multilayer Ceramic Capacitor

Hereinafter, an example of a method of manufacturing a multilayer ceramic capacitor, which is an example of the multilayer ceramic capacitor according to the second example embodiment, will be described.

First, a dielectric sheet and an electrically conductive paste for manufacturing internal electrodes are prepared. The dielectric sheet and the electrically conductive paste for manufacturing the internal electrode layers include a binder (for example, a known organic binder) and a solvent (for example, a known organic binder).

Next, the electrically conductive paste for manufacturing internal electrodes is printed on the dielectric sheet in a predetermined pattern by, for example, screen printing or gravure printing to form an internal electrode pattern. Specifically, an electrically conductive paste layer is formed by applying a paste made of an electrically conductive material onto the dielectric sheet by a method such as the above-described printing method, for example. The paste made of an electrically conductive material is, for example, a paste obtained by adding an organic binder and an organic solvent to a metal powder. As for the dielectric sheet, a dielectric sheet for an outer layer on which an internal electrode pattern is not printed is also prepared.

With such a configuration, the dielectric sheet on which the internal electrode pattern corresponding to the first internal electrode layer 516a is formed and the dielectric sheet on which the internal electrode pattern corresponding to the second internal electrode layer 516b is formed are prepared.

More specifically, a screen plate for printing the first internal electrode layer 516a and a screen plate for printing the second internal electrode layer 516b may be separately prepared, and the internal electrode layers may be printed, for example, using a printing machine capable of separately printing the two types of screen plates.

The dielectric sheets with these internal electrode patterns formed thereon are used to manufacture a multilayer sheet. That is, by laminating a predetermined number of dielectric sheets for the outer layer on which the internal electrode pattern is not formed, a portion to be the first outer layer portion 515b1 adjacent to the first main surface 512a is formed. On the resultant product, a dielectric sheet on which an internal electrode pattern corresponding to the first internal electrode layer 516a is formed and a dielectric sheet on which an internal electrode pattern corresponding to the second internal electrode layer 516b is formed are alternately laminated to form a portion to be the effective layer portion 515a. Further, on the resultant product, a predetermined number of outer layer dielectric sheets on which no internal electrode pattern is formed are laminated to form a portion to be a second outer layer portion 515b2. A multilayer sheet is thereby manufactured.

Further, the multilayer sheet is pressed in the lamination direction by, for example isostatic pressing or the like to prepare a multilayer block.

Subsequently, the multilayer block is cut into a predetermined size to cut out multilayer chips. Thereafter, wet barrel polishing may be performed to round the corner portions and ridge portions of each of the multilayer chips.

Next, each of the multilayer chips is fired to produce the multilayer body 512. The firing temperature is, for example, preferably about 900° C. or more and about 1400° C. or less depending on the ceramic or the material of the internal electrode layers.

Subsequently, the base electrode layers 526 and 527 including the first main surface electrode portion, the second main surface electrode portion, the third main surface electrode portion, and the fourth main surface electrode portion are formed on the first main surface 512a and the second main surface 512b of the multilayer body 512, and a portion of each of the first lateral surface 512c, the second lateral surface 512d, the third lateral surface 512e, and the fourth lateral surface 512f.

Each of the first to fourth main surface electrode portions is formed by, for example, a sputtering method or screen printing as in the first example embodiment.

When each of the first to fourth main surface electrode portions is formed by a sputtering method, for example, the following steps are performed.
(2-1) A sputtered film is formed on the entire or substantially the entire surface of the multilayer body 512.
(2-2) Next, portions of the sputtered film to remain as the first main surface electrode portion 526a1 and the first main surface electrode portion 526b1 of the base electrode layer 526 and the first main surface electrode portion 527a1 and the first main surface electrode portion 527b1 of the base electrode layer 527, specifically, a portion of the first main surface 512a of the multilayer body 512 and a portion of each of the first lateral surface 512c, the second lateral surface 512d, the third lateral surface 512e, and the fourth lateral surface 512f, are covered with a mask made of a resin, for example.
(2-3) Next, the sputtered film is dissolved by an etching solution. As a result, the sputtered film other than the portion covered with the mask made of resin is removed from the multilayer body 512.
(2-4) Next, the resin mask is dissolved in an organic solvent. As a result, only the sputtered film corresponding to the mask of the resin remains on the multilayer body 512, and the sputtered film forms the first main surface electrode portion 526a1 and the first main surface electrode portion 526b1 of the base electrode layer 526 and the first main surface electrode portion 527a1 and the first main surface electrode portion 527b1 of the base electrode layer 527.
(2-5) Next, on the first main surface 512a of the multilayer body 512, portions exposed between each of the first main surface electrode portion 526al, the first main surface electrode portion 526b1, the first main surface electrode portion 527al, and the first main surface electrode portion 526bl, and portions of the first main surface electrode portion 526al, the first main surface electrode portion 526b1, the first main surface electrode portion 527al, and the first main surface electrode portion 527b1 formed in the above-described step (2-4) respectively corresponding to the first end portions 526a1t, 526b1t and 527a1t and 527b1t on the first main surface 512a are covered with a mask made of resin, for example.
(2-6) Next, as the surface of the multilayer body 512, a further sputtered film is formed on the surface of the sputtered film obtained in the step (2-4) and the surface of the mask obtained in the step (2-5).
(2-7) Next, on the sputtered film obtained in the step (2-6), portions to be left as the second main surface electrode portion 526a2, the second main surface electrode portion 526b2, the second main surface electrode portion 527a2, and the second main surface electrode portion 527b2, more specifically, portions corresponding to a portion of the first main surface 512a and a portion of each of the first lateral surface 512c, the second lateral surface 512d, the third lateral surface 512e, and the fourth lateral surface 512f of the multilayer body 512, are covered with a mask made of a resin, for example. In addition, the mask in this step is formed so that the length along the direction connecting between the end portion of the first main surface electrode portion of the base electrode layer of the multilayer body 512 adjacent to the middle of the multilayer body 512 and the surface of the multilayer body 512 where each of the first internal electrode layer 516a and the second internal electrode layer 516b is exposed is shorter than resultant product formed in the previous step (2-2).
(2-8) Next, the sputtered film obtained in the step (2-6) is dissolved with an etching solution. As a result, the sputtered film other than the portion covered with the mask made of resin is removed from the multilayer body 512.
(2-9) Next, the resin mask obtained in the step (2-5) and the step (2-7) is dissolved in an organic solvent. As a result, only the sputtered film corresponding to the mask of the resin remains on the multilayer body 512, and the sputtered film forms the second main surface electrode portion 526a2 and the second main surface electrode portion 526b2 of the base electrode layer 526 and the second main surface electrode portion 527a2 and the second main surface electrode portion 527b2 of the base electrode layer 527.
(2-10) Thereafter, the step (2-5) to the step (2-9) are repeated to sequentially form the third main surface electrode portion and the fourth main surface electrode portion. In addition, the mask in the step (2-5) in a case of sequentially forming the third main surface electrode portion and the fourth main surface electrode portion is formed so that the length along the direction connecting between the end portion of the first main surface electrode portion of the base electrode layer of the multilayer body 512 adjacent to the middle of the multilayer body 512 and the surface of the multilayer body 512 where each of the first internal electrode layers 516a and the second internal electrode layers 516b is exposed is longer than the resultant product formed in the previous step (2-5).

With such a configuration, as shown in FIG. 14, when the length of the first main surface electrode portion 526a1 is defined as length A, the length of the second main surface electrode portion 526a2 is defined as length B, the length of the third main surface electrode portion 526a3 is defined as length C, and the length of the fourth main surface electrode portion 526a4 is defined as length D, the relationship of length A>length B>length C>length D is satisfied.

Similarly, when the length of the first main surface electrode portion 527b1 is defined as length A, the length of the second main surface electrode portion 527b2 is defined as length B, the length of the third main surface electrode portion 527b3 is defined as length C, and the length of the fourth main surface electrode portion 527b4 is defined as length D, the relationship of length A>length B>length C>length D is satisfied.

Further, as shown in FIG. 15, when the length of the first main surface electrode portion 526b1 is defined as length A, the length of the second main surface electrode portion 526b2 is defined as length B, the length of the third main surface electrode portion 526b3 is defined as length C, and the length of the fourth main surface electrode portion 526b4 is defined as length D, the relationship of length A>length B>length C>length D is satisfied.

Similarly, when the length of the first main surface electrode portion 527a1 is defined as length A, the length of the second main surface electrode portion 527a2 is defined as length B, the length of the third main surface electrode portion 527a3 is defined as length C, and the length of the fourth main surface electrode portion 527a4 is defined as length D, the relationship of length A>length B>length C>length D is satisfied.

Further, as in the multilayer ceramic capacitor 310 shown in FIG. 9, when the base electrode layers 526 and 527 including the first main surface electrode portion, the second main surface electrode portion, the third main surface electrode portion, and the fourth main surface electrode portion are formed only on the first main surface 512a, the resin mask obtained in the step (2-2) and the step (2-7) is formed so as not to cover the first lateral surface 512c, the second lateral surface 512d, the third lateral surface 512e, and the fourth lateral surface 512f of the multilayer body 512.

Next, in a case of the formation by screen printing, for example, the following steps are performed. That is, the printing plate is changed for each main surface electrode of each layer, and a printing pattern corresponding to the shape of a desired main surface electrode portion is formed at a desired position of the multilayer body 512.

At this time, the opposing interval of the pair of print patterns formed on the first main surface 512a of the multilayer body 512 in each of the width direction y and the length direction z is formed such that, among a case of forming the first main surface electrode portion, a case of forming the second main surface electrode portion, a case of forming the third main surface electrode portion, and a case of forming the fourth main surface electrode portion, the length along the direction connecting between the end portion of the first main surface electrode portion of the base electrode layer adjacent to the middle of the multilayer body and the surface of the multilayer body 512 where the first internal electrode layers are exposed is longer for the earlier formed main surface electrode portions than the later formed main surface electrode portions.

As a result, in the same or substantially the same manner as in the case where the multilayer ceramic capacitor is formed by the sputtering method, it is possible to obtain the configuration of the first to fourth main surface electrode portions as in the multilayer ceramic capacitor 510 shown in FIGS. 14 and 15.

Thereafter, plated layers 528 and 529 are formed on the surfaces of the fourth main surface electrode portions of the base electrode layers 526 and 527. The plated layers 528 and 529 are formed by barrel plating, for example. As in the multilayer ceramic capacitor 510 shown in FIGS. 12 to 15, when the plated layers 528 and 529 include the lower plated layers 530 and 531 and the upper plated layers 532 and 533, the respective plated layers are sequentially formed by barrel plating, for example.

When the plated layer 528 is directly formed as a plated layer, the following process is performed.

That is, plating is performed on the first lateral surface 512c to the fourth lateral surface 512f of the multilayer body 512, and a plating film is directly formed on each of the exposed portions of the first extension electrode portions 520a and the second extension electrode portions 520b of the internal electrode layers 516. When plating is performed, either electrolytic plating or electroless plating may be used, but electroless plating requires pretreatment with a catalyst or the like in order to improve the plating deposition rate, and has the disadvantage of complicating the process. Therefore, in general, electrolytic plating is preferably used. As the plating method, for example, barrel plating is preferably used. In addition, if necessary, the plated layer 528 serving as a direct plated layer may include a plurality of layers as in the multilayer ceramic capacitor 310 shown in FIG. 9, for example, and the upper plating electrode formed on the surface of the lower plating electrode may be formed in the same manner.

As described above, it is possible to manufacture the multilayer ceramic capacitor 510 shown in FIG. 11.

According to the example of a method of manufacturing the multilayer ceramic capacitor according to the present example embodiment described above, the end portions of the first to fourth main surface electrode portions formed on the first main surface of the multilayer body are provided so as not to be aligned with one another, such that locations where stress is generated are dispersed, and it is possible to reduce or prevent cracks from extending from the tip of the external electrode to the interior of the multilayer ceramic capacitor.

### C. Third Example Embodiment

### 1. Multilayer Ceramic Capacitor

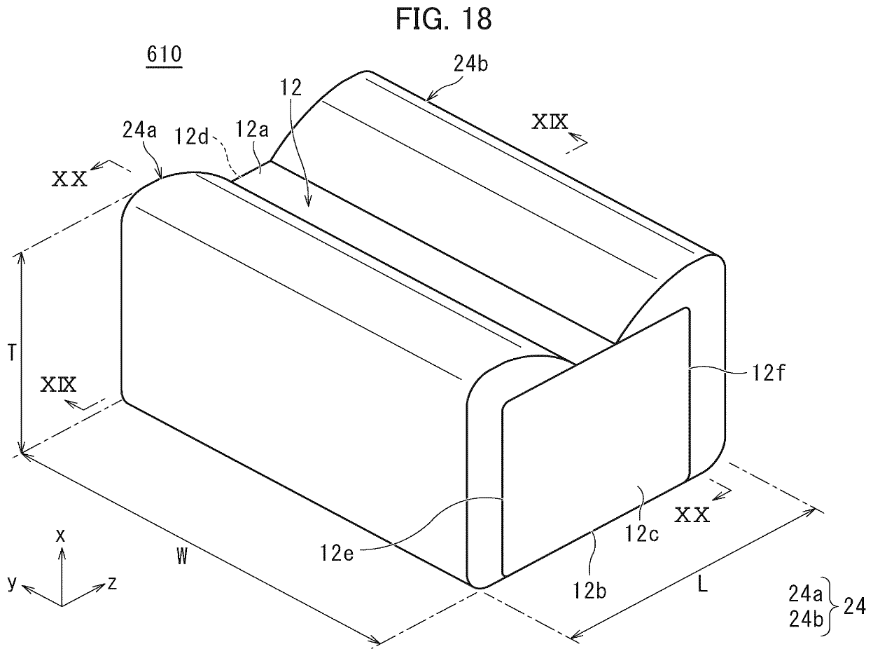

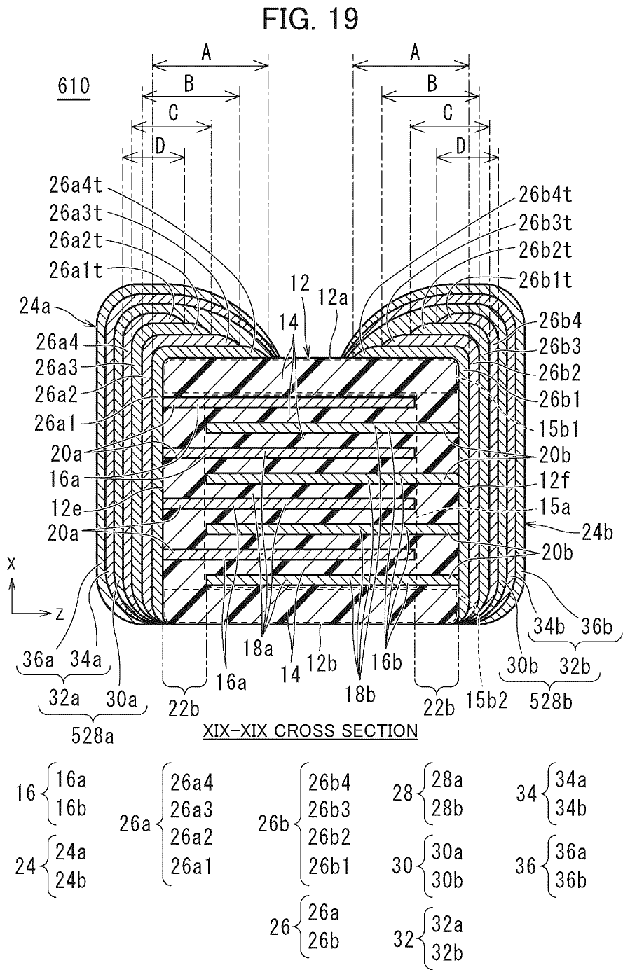

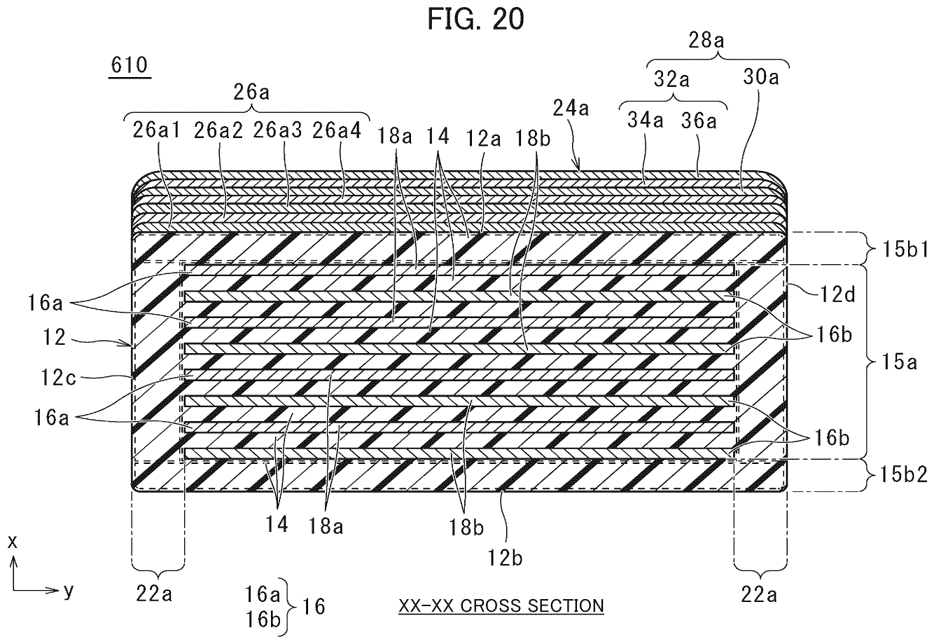

Next, a multilayer ceramic capacitor according to a third example embodiment of the present invention will be described. FIG. 18 is an external perspective view showing a multilayer ceramic capacitor as an example of a multilayer ceramic electronic component according to a third example embodiment of the present invention. FIG. 19 is a schematic cross-sectional view taken along the line XIX-XIX in FIG. 18. FIG. 20 is a schematic cross-sectional view taken along the line XX-XX in FIG. 18. However, components that are the same as or equivalent to those of the multilayer ceramic capacitor 10 of the first example embodiment shown in FIGS. 1 to 10 are denoted by the same reference numerals, and detailed descriptions thereof will be omitted.

The multilayer ceramic capacitor 610 according to the third example embodiment of the present invention includes the multilayer body 12 having the same or substantially the same configuration as that of the multilayer ceramic capacitor 10 according to the first example embodiment, and the external electrode 24. However, relative to the multilayer ceramic capacitor 10 of the first example embodiment, the L dimension and the W dimension of the multilayer ceramic capacitor 610 are switched.

Specifically, the dimensions of the multilayer ceramic capacitor 610 are, for example, preferably such that the L dimension in the length direction z is about 0.1 mm or more and about 2.5 mm or less, the T dimension in the height direction x is about 0.04 mm or more and about 2.5 mm or less, and the W dimension in the width direction y is about 0.2 mm or more and about 3.2 mm or less.

The multilayer ceramic capacitor 610 shown in FIG. 18 having the above-described configuration has the same or substantially the same advantageous effects as those of the multilayer ceramic capacitor 10 of the first example embodiment.

In the multilayer ceramic capacitor according to the third example embodiment of the present invention, the external electrode 24 of the multilayer ceramic capacitor 610 preferably includes the same or substantially the same first to fourth modifications as the external electrode 24 of the first to fourth modifications of the multilayer ceramic capacitor 10 according to the first example embodiment.

### 2. Method of Manufacturing Multilayer Ceramic Capacitor

Hereinafter, an example of a method of manufacturing a multilayer ceramic capacitor, which is an example of the multilayer ceramic capacitor according to the third example embodiment, will be described.

The example method of manufacturing the multilayer ceramic capacitor according to the third example embodiment is the same or substantially the same as the method of manufacturing the multilayer ceramic capacitor according to the first example embodiment. However, relative to the multilayer ceramic capacitor 10 of the first example embodiment, the multilayer ceramic capacitor according to the third example embodiment is produced such that the L dimension and the W dimension are switched.

As described above, it is possible to manufacture the multilayer ceramic capacitor 610 shown in FIG. 18.

According to the method of manufacturing the multilayer ceramic capacitor according to the present example embodiment described above, the end portions of the first to fourth main surface electrode portions formed on the first main surface of the multilayer body are provided so as not to be aligned with one another, such that locations where stress is generated are dispersed, and it is possible to reduce or prevent cracks from extending from the tip of the external electrode to the interior of the multilayer ceramic capacitor.

As described above, example embodiments of the present invention and modifications thereof are disclosed in the above description, but the present invention is not limited thereto.

In other words, various modifications in terms of the mechanism, shape, material, quantity, position, arrangement, and the like can be made to the above-described example embodiments and modifications thereof without departing from the technical ideas and scope of the present invention, and these modifications are included in the present invention.

While example embodiments of the present invention and modifications thereof have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first main surface and a second main surface opposed to each other in a lamination direction of the plurality of ceramic layers, a first lateral surface and a second lateral surface opposed to each other in a width direction orthogonal or substantially orthogonal to the lamination direction, a first end surface and a second end surface opposed to each other in a length direction orthogonal or substantially orthogonal to the lamination direction and the width direction, a plurality of first internal electrode layers each exposed at the first end surface;
a first external electrode covering a portion of the first main surface and at least a portion of the first end surface of the multilayer body; and
a second external electrode covering a portion of the first main surface and at least a portion of the second end surface of the multilayer body; wherein
each of the first external electrode and the second external electrode includes:
a first main surface electrode portion on the first main surface;
a second main surface electrode portion on a portion of the first main surface electrode portion;
a third main surface electrode portion on a portion of the second main surface electrode portion; and
a fourth main surface electrode portion on a portion of the third main surface electrode portion; and
on the first main surface, when a length of the first main surface electrode portion in the length direction is defined as length A, a length of the second main surface electrode portion in a same direction as the length A is defined as length B, a length of the third main surface electrode portion in the same direction as the length A is defined as length C, and a length of the fourth main surface electrode portion in the same direction as the length A is defined as length D, a relationship of length A>length B>length C>length D is satisfied.

2. The multilayer ceramic capacitor according to claim 1, wherein the multilayer ceramic capacitor has a dimension in the length direction larger than a dimension in the width direction.

3. The multilayer ceramic capacitor according to claim 1, wherein the multilayer ceramic capacitor has a dimension in the width direction larger than a dimension in the length direction.

4. The multilayer ceramic capacitor according to claim 1, wherein a ratio of a dimension of the multilayer ceramic capacitor in the width direction to a dimension of the multilayer ceramic capacitor in the length direction is about 0.85 or more and about 1.00 or less; and
a third external electrode covering a portion of the first main surface and at least a portion of the first lateral surface of the multilayer body; and
a fourth external electrode covering a portion of the first main surface and at least a portion of the third lateral surface of the multilayer body.

5. The multilayer ceramic capacitor according to claim 4, wherein the plurality of first internal electrode layers each exposed at the first lateral surface; and
on the first main surface, when a length of the first main surface electrode portion in the width direction is defined as length E, a length of the second main surface electrode portion in a same direction as the length E is defined as length F, a length of the third main surface electrode portion in the same direction as the length E is defined as length G, and a length of the fourth main surface electrode portion in the same direction as the length E is defined as length H, a relationship of length E>length F>length G>length H is satisfied.

6. The multilayer ceramic capacitor according to claim 2, wherein the fourth main surface electrode portion defines an outermost layer.

7. The multilayer ceramic capacitor according to claim 3, wherein the fourth main surface electrode portion defines an outermost layer.

8. The multilayer ceramic capacitor according to claim 4, wherein the fourth main surface electrode portion defines an outermost layer.

9. The multilayer ceramic capacitor according to claim 2, wherein
the first main surface electrode portion further extends to a surface orthogonal or substantially orthogonal to the first main surface;
the second main surface electrode portion further extends to a surface orthogonal or substantially orthogonal to the first main surface;
the third main surface electrode portion further extends to a surface orthogonal or substantially orthogonal to the first main surface; and
the fourth main surface electrode portion further extends to a surface orthogonal or substantially orthogonal to the first main surface.

10. The multilayer ceramic capacitor according to claim 3, wherein
the first main surface electrode portion further extends to a surface orthogonal or substantially orthogonal to the first main surface;
the second main surface electrode portion further extends to a surface orthogonal or substantially orthogonal to the first main surface;
the third main surface electrode portion further extends to a surface orthogonal or substantially orthogonal to the first main surface; and
the fourth main surface electrode portion further extends to a surface orthogonal or substantially orthogonal to the first main surface.

11. The multilayer ceramic capacitor according to claim 4, wherein
the first main surface electrode portion further extends to a surface orthogonal or substantially orthogonal to the first main surface;
the second main surface electrode portion further extends to a surface orthogonal or substantially orthogonal to the first main surface;
the third main surface electrode portion further extends to a surface orthogonal or substantially orthogonal to the first main surface; and
the fourth main surface electrode portion further extends to a surface orthogonal or substantially orthogonal to the first main surface.

12. The multilayer ceramic capacitor according to claim 9, wherein
the first main surface electrode portion further extends to a surface orthogonal or substantially orthogonal to the first main surface;
the second main surface electrode portion further extends to a surface orthogonal or substantially orthogonal to the first main surface;
the third main surface electrode portion further extends to a surface orthogonal or substantially orthogonal to the first main surface; and
the fourth main surface electrode portion further extends to a surface orthogonal or substantially orthogonal to the first main surface.

13. The multilayer ceramic capacitor according to claim 10, wherein
the first main surface electrode portion further extends to a surface orthogonal or substantially orthogonal to the first main surface;
the second main surface electrode portion further extends to a surface orthogonal or substantially orthogonal to the first main surface;
the third main surface electrode portion further extends to a surface orthogonal or substantially orthogonal to the first main surface; and
the fourth main surface electrode portion further extends to a surface orthogonal or substantially orthogonal to the first main surface.

14. The multilayer ceramic capacitor according to claim 11, wherein
the first main surface electrode portion further extends to a surface orthogonal or substantially orthogonal to the first main surface;
the second main surface electrode portion further extends to a surface orthogonal or substantially orthogonal to the first main surface;
the third main surface electrode portion further extends to a surface orthogonal or substantially orthogonal to the first main surface; and
the fourth main surface electrode portion further extends to a surface orthogonal or substantially orthogonal to the first main surface.
